(19) United States
(12) Patent Application Publication
(10) Pub. No.: US 2023/0052257 A1
(43) Pub. Date: Feb. 16, 2023

(54) LAWN MOWER ROBOT AND CONTROL METHOD FOR SAME

(71) Applicant: LG ELECTRONICS INC., Seoul (KR)

(72) Inventor: Byoungsuk CHOI, Seoul (KR)

(21) Appl. No.: 17/794,337

(22) PCT Filed: Feb. 3, 2020
(86) PCT No.: PCT/KR2020/001559

§ 371 Date: Jul. 21, 2022

(30) Foreign Application Priority Data
Jan. 23, 2020 (KR) 10-2020-0009503

(51) Int. Cl. A01D 34/00

(52) U.S. Cl. CPC A01D 34/008; A01D 2101/00

(57) ABSTRACT

Disclosed are a lawn mower robot and a control method for same. A lawn mower robot and a control method for same according to an embodiment of the present invention can sense height information about the height between a lawn and the lower side of the lawn mower robot. The sensed height information is used as supporting data for calculating whether the lawn mower robot has deviated from a preset travel path, as well as the deviation direction. Accordingly, even when a separate sensing means is not provided, whether the lawn mower robot has deviated from the preset travel path is calculated using the height information about the height from the ground, and thus the lawn mower can be returned to the preset travel path.

### TECHNICAL FIELD

The present disclosure relates to a lawn mower robot and a method for controlling the same, and one particular implementation relates to a lawn mower robot, which is capable of detecting whether the robot is moving to be biased to left or right with respect to a designated travel path, and adjusting the travel path according to a result of the detection, and a method for controlling the same.

### BACKGROUND ART

A lawn mower robot is a machine for mowing grass or lawn by moving itself according to preset control information. A user may input in advance control information related to desired mowing motion, time, and period. The lawn mower robot operates according to the input control information.

The lawn mower robot may perform a task while moving along a preset path in a specific area. In order to determine whether the lawn mower robot travels along the path, the lawn mower robot may be provided with an encoder sensor and a gyro sensor.

The encoder sensor may detect turns of wheels of the lawn mower robot, a wheel turn time, and the like. Using the detected wheel turns and wheel turn time, a distance traveled by the lawn mower robot and a traveling direction may be computed.

The lawn mower robot may move along a preset travel (moving, driving) route (path). In this case, the preset travel path may partially overlap in a widthwise direction. This is to allow the lawn mower robot to perform a lawn mowing operation while completely traveling an area where the lawn mowing operation is to be performed.

However, in an environment in which the lawn mower robot runs, soil or gravels are generally scattered. Accordingly, as the lawn mower robot continues to travel, the probability that the lawn mower robot deviates from a preset travel route increases.

In this case, the lawn mower robot may re-enter an area where the lawn mowing operation has already been performed. Or, there may be a case where the lawn mower robot travels out of a preset travel path and runs with deviating from an area where the lawn mowing operation has been performed.

Accordingly, technologies have been introduced for determining whether the lawn mower robot has deviated from a preset travel path during movement, and guiding the robot to continuously run along the preset travel path.

Korean Registration Patent Application No. 10-1513050 discloses a lawn mower robot and a control method thereof. Specifically, the application discloses a lawn mower robot capable of setting a task area using coordinates of each vertex formed by boundary wires and performing pattern driving within the set task area, and a control method thereof.

However, this type of lawn mower robot and its control method have limitation in that they can be utilized only within the task area set by the boundary wires. That is, the prior art document is difficult to be applied when a lawn mowing operation is to be performed in an open area where a boundary wire is not provided.

Korean Publication Patent Application No. 10-2017-0123512 discloses a moving robot and a control method thereof. Specifically, the patent document discloses a moving robot that detects rotation angles of first and second caster wheels rotated in response to its travel, and controls an operation of driving wheels according to a result of the detection, and a control method thereof.

However, this type of moving robot and its control method have a limitation in that it is difficult to consider arbitrary rotation of the caster wheels. That is, the caster wheels are coupled to a body to be rotatable even without additional power. Accordingly, even when the moving robot travels along a preset path, the caster wheels may be arbitrarily rotated.

Thus, in the prior art documents, it is possible to detect whether the moving robot has deviated from a preset path but it is difficult to guarantee reliability of detected information.

Korean Registration Patent Application No. 10-1513050 (Apr. 17, 2015)

Korean Publication Patent Application No. 10-2017-0123512 (Nov. 8, 2017)

### DISCLOSURE OF INVENTION

### Technical Problem

The present disclosure relates to a lawn mower robot capable of solving those drawbacks, and a method for controlling the same.

First, one aspect of the present disclosure is to provide a lawn mower robot, capable of easily computing whether it has deviated from a preset travel path (route), and a method for controlling the same.

Another aspect of the present disclosure is to provide a lawn mower robot, capable of easily computing a deviation direction when it has deviated from a preset travel path (route), and a method for controlling the same.

Still another aspect of the present disclosure is to provide a lawn mower robot, capable of easily identifying information related to an area where the lawn mower robot is to enter during traveling, and a method for controlling the same.

Still another aspect of the present disclosure is to provide a lawn mower robot, capable of improving reliability of information related to a travel of the lawn mower robot which is traveling, and a method for controlling the same.

Still another aspect of the present disclosure is to provide a lawn mower robot, capable of efficiently mowing lawn by excluding redundant performance of a lawn mowing task in an area in which the lawn mower robot travels, and a method for controlling the same.

### Technical Solution

In order to achieve the above aspects and other advantages, there is provided a lawn mower robot that may include a body unit, main wheels provided in plurality and arranged to face each other at a distance therebetween, the main wheels rotatably coupled to the body unit, a power module provided in plurality to be connected to the main wheels, respectively, and configured to be rotated according to operation information so as to rotate the main wheels, a blade located between the plurality of main wheels and rotatably coupled to a lower side of the body unit, a plurality of height sensor modules located at the front of the blade on the lower side of the body unit, and configured to detect height information of the lower side of the body unit with respect to a ground, and a control unit communicatively connected to the power modules and the height sensor modules, respectively, and configured to calculate the operation information using the detected height information, and rotate the power module according to the calculated operation information. Some of the plurality of height sensor modules may be located to be biased to any one of the plurality of main wheels, and remaining height sensor modules of the plurality of height sensor modules may be located to be biased to another one of the plurality of main wheels.

The plurality of height sensor modules of the lawn mower robot may include a first height sensor module and a second height sensor module located to be biased toward the one main wheel and spaced apart from each other, and a third height sensor module and a fourth height sensor module located to be biased toward the another main wheel and spaced apart from each other.

The first height sensor module of the lawn mower robot may be located between the one main wheel and the blade, and the second height sensor module may be located to at least partially overlap the blade in front and rear directions.

The third height sensor module of the lawn mower robot may be located between the another main wheel and the blade, and the fourth height sensor module may be located to at least partially overlap the blade in front and rear directions.

The control unit of the lawn mower robot may calculate deviation information using first height information detected by the first height sensor module, second height information detected by the second height sensor module, and preset reference height information, and calculate the operation information using the calculated deviation information. The deviation information may be information related to whether the lawn mower robot travels to be biased to one side or another side or travels straight.

The control unit of the lawn mower robot may calculate deviation information using third height information detected by the third height sensor module, fourth height information detected by the fourth height sensor module, and preset reference height information, and calculate the operation information using the calculated deviation information. The deviation information may be information related to whether the lawn mower robot travels to be biased to one side or another side or travels straight.

Each of the plurality of height sensor modules of the lawn mower robot may detect a plurality of height information, and the control unit may calculate the operation information by using any one height information having a minimum value among the plurality of the height information detected by each of the plurality of height sensor modules.

The plurality of height sensor modules may include a first height sensor module located between the one main wheel and the blade, and configured to detect first height information related to an area between the one main wheel and the blade, and a second height sensor module located to be opposite to the one main wheel with the first height sensor module interposed therebetween, and located to at least partially overlap the blade in front and rear directions to detect second height information related to an overlapping area with the blade in the front and rear directions.

The plurality of height sensor modules of the lawn mower robot may include a third height sensor module located between the another main wheel and the blade, and configured to detect third height information related to an area between the another main wheel and the blade, and a fourth height sensor module located to be opposite to the another main wheel with the third height sensor module interposed therebetween, and located to at least partially overlap the blade in the front and rear directions to detect fourth height information related to an overlapping area with the blade in the front and rear directions.

The blade of the lawn mower robot may be rotatably coupled to the lower side of the body unit, and includes a plate formed in a disc shape having a predetermined width. The plate may include a first sub blade located to be adjacent to the one main wheel and extending toward the one main wheel, and a second sub blade located to be adjacent to the another main wheel and extending toward the another main wheel.

The first height sensor module of the lawn mower robot may be located between an end portion of the first sub blade facing the one main wheel and the one main wheel, and the second height sensor module may be disposed such that the end portion of the first sub blade is located between the one main wheel and the second height sensor module.

The third height sensor module of the lawn mower robot may be located between an end portion of the second sub blade facing the another main wheel and the another main wheel, and the fourth height sensor module may be disposed such that the end portion of the second sub blade is located between the another main wheel and the fourth height sensor module.

In order to achieve the above aspects and other advantages, there is provided a method for controlling a lawn mower robot. The method may include (a) detecting, by a height sensor unit, a plurality of height information, (b) calculating, by a control unit, deviation information using the detected height information, (c) calculating, by the control unit, operation information using the calculated deviation information, and (d) controlling, by the control unit, power modules according to the calculated operation information.

The step (a) of the method for controlling the lawn mower robot may include (a1) detecting, the first height sensor module, first height information, (a2) detecting, the second height sensor module, second height information, (a3) detecting, the third height sensor module, third height information, and (a4) detecting, by the fourth height sensor module, fourth height information.

The step (b) of the method for controlling the lawn mower robot may include (b1) calculating, by a reference direction information calculation unit, reference direction information, (b2) calculating, by a deviation information calculation unit, deviation information by comparing the detected first height information and second height information and preset reference direction information when the calculated reference direction information is one side (right side), (b3) calculating, by the deviation information calculation unit, deviation information by comparing the detected third height information and fourth height information and the preset reference direction information when the calculated reference direction information is another side (left side), and (b4) calculating, by the deviation information calculation unit, third deviation information when the calculated reference direction information is still another side (front side).

The step (b2) of the method for controlling the lawn mower robot may include (b21) comparing, by the deviation information calculation unit, the first height information and the second height information with the preset reference height information when the detected first height information is equal to the detected second height information, (b22) calculating, by the deviation information calculation unit, first deviation information when the first height information and the second height information are equal to or higher than the reference height information, and (b23) calculating, by the deviation information calculation unit, second deviation information when the first height information and the second height information are lower than the reference height information.

The step (b2) of the method for controlling the lawn mower robot may include (b24) comparing, by the deviation information calculation unit, the first height information with the preset reference height information when the detected first height information exceeds the detected second height information, and (b25) calculating, by the deviation information calculation unit, third deviation information when the detected first height information is equal to or higher than the reference height information.

The step (b3) of the method for controlling the lawn mower robot may include (b31) comparing, by the deviation information calculation unit, the third height information and the fourth height information with the preset reference height information when the detected third height information is equal to the detected fourth height information, (b32) calculating, by the deviation information calculation unit, second deviation information when the third height information and the fourth height information are equal to or higher than the reference height information, and (b33) calculating, by the deviation information calculation unit, first deviation information when the third height information and the fourth height information are lower than the reference height information.

The step (b3) of the method for controlling the lawn mower robot may include (b34) comparing, by the deviation information calculation unit, the third height information with the preset reference height information when the detected third height information exceeds the detected fourth height information, and (b35) calculating, by the deviation information calculation unit, third deviation information when the detected third height information is equal to or higher than the reference height information.

The step (c) of the method for controlling the lawn mower robot may include (c1) calculating, by an operation information calculation module, the operation information as first operation information for rotating a first power module faster than a second power module when a deviation information calculation unit calculates first deviation information, (c2) calculating, by the operation information calculation module, the operation information as second operation information for rotating the second power module faster than the first power module when the deviation information calculation unit calculates second deviation information, and (c3) calculating, by the operation information calculation module, the operation information as third operation information for rotating the first power module and the second power module at the same speed when the deviation information calculation unit calculates third deviation information.

The step (d) of the method for controlling the lawn mower robot may include (d1) controlling, by an operation control module, a first power module to rotate faster than a second power module when an operation information calculation module calculates first operation information, (d2) controlling, by the operation control module, the second power module to rotate faster than the first power module when the operation information calculation module calculates second operation information, and (d3) controlling, by the operation control module, the first power module and the second power module to rotate at the same speed when the operation information calculation module calculates third operation information.

### Advantageous Effects of Invention

According to the present disclosure, the following effects can be achieved.

First, a lawn mower robot is provided with a plurality of height sensor modules. Each height sensor module is located on a front side of a blade, and thus is located at the front of the blade on a path that the lawn mower robot travels. Each height sensor module is configured to detect whether there is grass or the like on a path along which the lawn mower robot is to travel and a distance from the grass.

The plurality of height sensor modules are disposed to be spaced apart from each other in left and right directions. Each height sensor module detects height information in a different area. A control unit may calculate deviation information by using the height information detected by each of the plurality of height sensor modules.

Accordingly, the control unit can easily calculate whether the traveling lawn mower robot has deviated from a preset travel path according to the calculated deviation information.

A deviation information calculation module calculates deviation information by using the height information detected by the plurality of height sensor modules. The calculated deviation information is transmitted to an operation information calculation module. The operation information calculation module calculates operation information according to the calculated deviation information. The calculated operation information may be information for independently operating power modules that rotate main wheels located on left and right sides of the lawn mower robot, respectively.

Accordingly, when the traveling lawn mower robot has deviated from the preset travel path, the operation information calculation module calculates operation information to operate the lawn mower robot in an opposite direction to a direction in which it is currently traveling.

The calculated operation information is transmitted to an operation control module. The operation control module controls a first power module and a second power module according to the calculated operation information.

Accordingly, even when the running lawn mower robot has deviated from the preset travel path, the lawn mower robot can easily re-enter the preset travel path according to the calculated deviation information and operation information.

Also, according to one implementation, a database unit stores information related to an area through which the lawn mower robot has passed and an area that the lawn mower robot is to travel. The information stored in the database unit is stored for each different identifier according to a movement of the lawn mower robot.

This can facilitate expression of an area through which the lawn mower robot has already passed, an area through which the lawn mower robot is to travel, and an area through which the lawn mower robot has not passed.

In addition, a height sensor unit can detect a plurality of height information. The height sensor unit detects height information until the number of detected height information exceeds a predetermined number. Accordingly, a scale of a population for sampling can be increased, which can improve reliability of selected height information.

A deviation information calculation module selects height information having a minimum value among a plurality of detected height information. Accordingly, a height of lawns having irregular shapes can be obtained from more reliable information.

With the configuration, the lawn mower robot can be controlled to travel away from a previously passed path and to travel close to an area where a new lawn mowing operation is to be performed.

This can prevent a repeated execution of the lawn mowing operation in an area where the lawn mower robot is traveling, and can also control the lawn mower robot to move toward an area where the lawn mowing operation is to be performed, such that the lawn mower robot can efficiently perform the lawn mowing operation.

### BRIEF DESCRIPTION OF DRAWINGS

FIG. 1 is a perspective view illustrating appearance of a lawn mower robot in accordance with an implementation.

FIG. 2 is a lateral view illustrating the lawn mower robot of FIG. 1.

FIG. 3 is a schematic view illustrating a front surface of the lawn mower robot of FIG. 1.

FIG. 4 is a schematic view illustrating a rear surface of the lawn mower robot of FIG. 1.

FIGS. 5 and 6 are block diagrams illustrating a configuration for implementing a method for controlling a lawn mower robot in accordance with an implementation.

FIG. 7 is a flowchart illustrating a method for controlling a lawn mower robot in accordance with an implementation.

FIG. 8 is a flowchart illustrating detailed steps of a step S100 in the control method of FIG. 7.

FIG. 9 is a flowchart illustrating detailed steps of a step S200 in the control method of FIG. 7.

FIG. 10 is a flowchart illustrating detailed steps of a step S300 in the control method of FIG. 7.

FIG. 11 is a flowchart illustrating detailed steps of a step S400 in the control method of FIG. 7.

FIG. 12 is a flowchart illustrating detailed steps of a step S500 in the control method of FIG. 7.

FIG. 13 is a flowchart illustrating detailed steps of a step S600 in the control method of FIG. 7.

FIG. 14 is a flowchart illustrating a state in which the lawn mower robot in accordance with the implementation travels.

FIGS. 15 (a) and (b) are flowcharts illustrating a state in which the lawn mower robot in accordance with the implementation travels with being biased to one side.

FIGS. 16 (a) and (b) are flowcharts illustrating a state in which the lawn mower robot in accordance with the implementation travels with being biased to another side.

FIGS. 17 (a) and (b) are conceptual views illustrating a state in which the lawn mower robot in accordance with the implementation travels forward.

FIGS. 18 (a) and (b) are conceptual views illustrating an example of travel record information related to a record that the lawn mower robot according to the implementation has traveled.

FIGS. 19 to 24 are conceptual views illustrating an example of travel record information related to a record that the lawn mower robot according to the implementation has traveled by being controlled according to the control method according to the implementation.

### MODE FOR THE INVENTION

Hereinafter, a lawn mower robot according to an implementation and a method for controlling the same will be described in detail, with reference to the accompanying drawings.

In the following description, description of some components may be omitted in order to clarify the technical characteristics of this disclosure.

### 1. Definition of Terms

The term “lawn” or “grass” as used in the following description means any plant that is growing on a specific area and can be mowed or cut by a lawn mower robot 10.

As used in the following description, the term “work” or “task” means a series of operations performed by the lawn mower robot 10 to mow and keep lawns, grass and the like in a specific area.

The term “advancing”, “moving forward” or “proceeding” as used in the following description means an operation in which the lawn mower robot 10 moves in a specific direction to perform a task.

As used in the following description, the term “moving backward” or “reversing” means an operation in which the lawn mower robot 10 moves in a direction opposite to a specific direction in which the lawn mower robot 10 moves to perform a task.

As used in the following description, the term “electrically connected” means that one component and another component are electrically connected to each other or connected to perform information communication. The electrical connection may be achieved by a conducting wire, in a wired manner such as a communication cable, or in a wireless manner such as Bluetooth or Wi-Fi.

First to fourth height information H1, H2, H3, and H4 and preset reference height information R.H used in the following description may be expressed by specific numerical values. In an implementation, the specific numerical value may be in units of centimeters (cm).

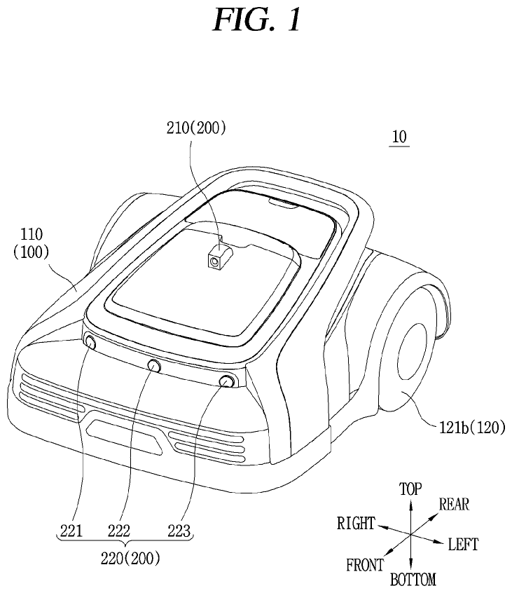

The terms “front side”, “rear side”, “upper side”, “lower side”, “right side”, and “left side” used in the following description will be understood with reference to a coordinate system shown in FIG. 1. Also, it will be understood that the direction is set based on a situation in which the lawn mower robot 10 travels forward.

### 2. Description of Configuration of Lawn Mower Robot 10 According to Implementation

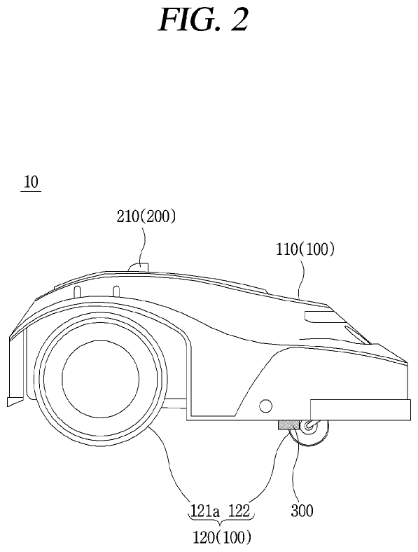

Referring to FIGS. 1 and 2, a lawn mower robot 10 according to an implementation disclosed herein includes a body unit 100 and a travel sensor unit 200.

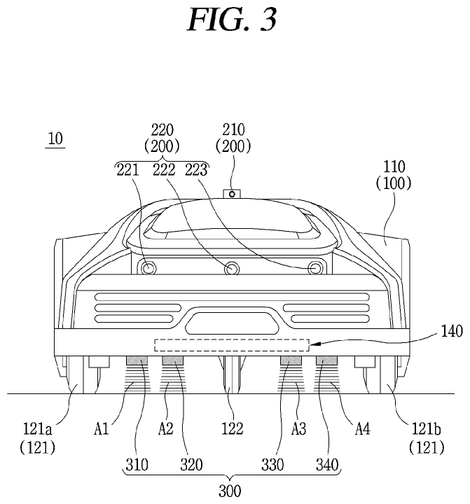

Referring to FIGS. 3 to 6, the lawn mower robot 10 according to the implementation includes a height sensor unit 300, a control unit 400, a database unit 500, and a communication unit 600.

Hereinafter, each component of the lawn mower robot 10 according to the implementation will be described with reference to the accompanying drawings, and the height sensor unit 300, the control part 400, the database unit 500, and the communication unit 600 will be explained as separate clauses.

(1) Description of Body Unit 100

The body unit 100 defines a body of the lawn mower robot 10. The body unit 100 includes a housing 110, a driving module 120, a power module 130, and a blade 140.

The housing 110 defines an outer side of the body unit 100.

The housing 110 is preferably formed of a lightweight and highly durable material. In one implementation, the housing 110 may be formed of a synthetic resin such as reinforced plastic or the like.

The travel sensor unit 200 may be partially disposed on an outer side of the housing 110. In addition, although not indicated by a reference numeral, a handle easily gripped by a user may be provided on the outer side of the housing 110.

A predetermined space is formed inside the housing 110. In the space, the part of the travel sensor unit 200, the control unit 400, and the database unit 500 may be disposed.

Openings are formed at both sides of the housing 110, namely, at both right and left sides in the illustrated implementation. A main wheel 121 is located in the openings.

An image sensor module 210 of the travel sensor unit 200 is located on one side of the housing 110, namely, on a top of the housing 110 in the illustrated implementation.

A sub wheel 122 is located on another side of the housing 110, namely, on a lower side of the housing 110 in the illustrated implementation. A blade 140 may also be disposed on the lower side of the housing 110 to perform a task for cutting the lawn.

The height sensor unit 300 is located on the another side of the housing 110, namely, on the lower side. The height sensor unit 300 may detect a distance between the another side of the housing 110 and the ground or an upper end portion of grass.

A distance sensor module 220 of the travel sensor unit 200 is located on another side of the housing 110, namely, on a front side in the illustrated implementation.

The driving module 120 functions as a component which allows the lawn mower robot 10 to travel. The driving module 120 is connected to the power module 130.

A driving force generated by the power module 130 is transmitted to the driving module 120, so that the lawn mower robot 10 can move to the front or to the rear. In addition, as will be described later, the power module 130 may be provided in plurality and driven independently.

Accordingly, the driving module 120 may also be independently driven to change a direction in which the lawn mower robot 10 travels.

The driving module 120 includes a main wheel 121 and a sub wheel 122.

The main wheel 121 is connected to the power module 130 and receives the driving force generated by the power module 130. The main wheel 121 is rotated by the driving force, so that the lawn mower robot 10 can move to the front or rear side.

In the illustrated implementation, the main wheel 121 is located on the rear side of the housing 110.

The main wheel 121 may be provided in plurality. In the illustrated implementation, the main wheel 121 includes a first main wheel 121a and a second main wheel 121b.

The first main wheel 121a is located in an opening formed at the rear right side of the housing 110. In addition, the second main wheel 121b is located in an opening formed at the rear left side of the housing 110.

The first main wheel 121a and the second main wheel 121b are disposed to face each other. The first main wheel 121a and the second main wheel 121b may be rotated independently of each other. To this end, the first main wheel 121a and the second main wheel 121b may be connected to a first power module 131 and a second power module 132, respectively.

The main wheel 121 may be formed in an arbitrary shape which is rotated by a rotational force so that the lawn mower robot 10 can move. In one implementation, the main wheel 121 may be provided in the form of a wheel.

The sub wheel 122 is located on a front lower side of the lawn mower robot 10. The sub wheel 122 supports the front side of the lawn mower robot 10.

In the illustrated implementation, only one sub wheel 122 is provided. Alternatively, the sub wheel 122 may be provided in plurality. In the alternative implementation, the lawn mower robot 10 can be stably supported by the plurality of sub wheels 122.

The sub wheel 122 may be provided in an arbitrary form to be rotatably coupled to the lawn mower robot 10. In one implementation, the sub wheel 122 may be provided in the form of a wheel.

When the main wheel 121 is steered, the sub wheel 122 may be rotated toward a direction in which the lawn mower robot 10 proceeds. Accordingly, it can be said that the sub wheel 122 functions as a caster.

The power module 130 generates a driving force for the lawn mower robot 10. The power module 130 may be electrically connected to the control unit 400 to receive operation information.

In one implementation, the power module 130 may be configured as a motor. The power module 130 may be accommodated in an inner space of the housing 110.

The power module 130 may receive power from outside. In one implementation, the power module 130 may receive power from a battery (not illustrated) disposed in the lawn mower robot 10. The power module 130 may be electrically connected to the battery (not illustrated).

The driving module 130 is connected to the main wheel 121. When the power module 130 is rotated, the main wheel 121 may also be rotated. Accordingly, the driving force generated by the power module 130 is transmitted to the main wheel 121.

The power module 130 may be provided in plurality. In the illustrated implementation, the power module 130 includes a first power module 131 and a second power module 132.

The first power module 131 is connected to the first main wheel 121a. When the first power module 131 is rotated, the first main wheel 121a may be rotated. The second power module 132 is connected to the second main wheel 121b. When the second power module 132 is rotated, the second main wheel 121b may be rotated.

Accordingly, the lawn mower robot 10 can move forward or backward by the first power module 131 and the second power module 132.

The first power module 131 and the second power module 132 may be driven independently of each other. That is, whether each of the first power module 131 and the second power module 132 rotates, the number of turns, etc. may be independently controlled. To this end, the first power module 131 and the second power module 132 may be electrically connected to the control unit 400, respectively.

As the first power module 131 and the second power module 132 are rotated at different speeds, whether the lawn mower rotor 10 travels, and a traveling direction and a traveling speed of the lawn mower robot can be controlled.

The blade 140 cuts the lawns located on the path along which the lawn mower robot 10 travels.

The blade 140 is located at the another side of the housing 110, namely, at the lower side in the illustrated implementation. The blade 110 is rotatably coupled to the housing 140. In one implementation, the blade 140 may be rotatably coupled to the lower side of the housing 110 by a rod (not illustrated).

The blade 140 is electrically connected to the control unit 400. The control unit 400 may control the blade 140 according to calculated operation information.

The blade 140 may receive external power. In one implementation, the blade 140 may receive power from a battery (not illustrated) disposed in the lawn mower robot 10. The blade 140 may be electrically connected to the battery (not illustrated).

The blade 140 includes a plate 141, a blade motor 142, and a sub blade 143.

The plate 141 is a portion at which the blade 140 is rotatably coupled to the housing 110. The plate 141 may be rotated as the blade motor 142 is rotated.

The plate 141 may be formed in a plate shape. In the illustrated implementation, the plate 141 is formed in a disc shape having a predetermined diameter d. The shape of the plate 141 may change.

A rod (not illustrated) may be coupled to a center of the plate 141. When the blade motor 142 is rotated, the rod (not illustrated) and the plate 141 may be rotated together.

The sub blade 143 may be coupled to the plate 141. Specifically, the sub blade 143 may be coupled to a portion of the plate 141 which is adjacent to an outer circumference in a direction facing the main wheel 121a, 121b, namely, in the left and right directions in the illustrated implementation.

When the plate 141 is rotated, the sub blade 143 is also rotated together with the plate 141. Accordingly, lawns located on the path along which the lawn mower robot travels can be mowed.

The outer circumference of the plate 141 may be located between height sensor modules 310, 320, 330, 340 to be described later.

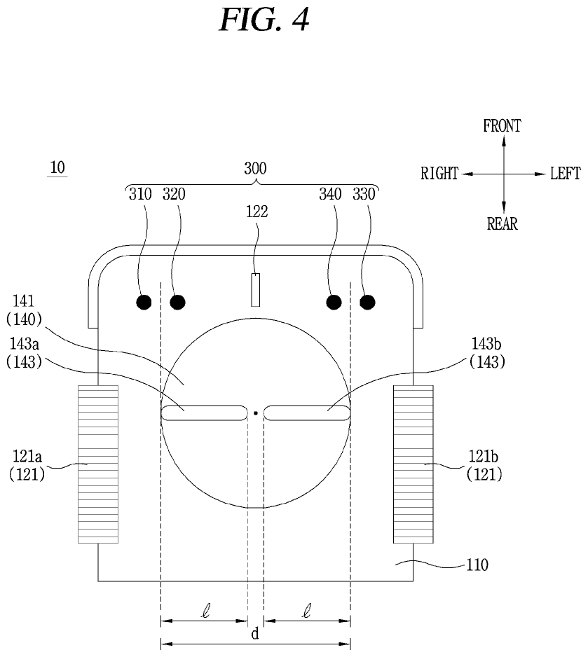

The structure will be described in detail with reference to FIG. 4 as follows.

An outer circumference of one side of the plate 141, namely, a right outer circumference in the illustrated implementation, is located between the first height sensor module 310 and the second height sensor module 320 in the left and right directions.

An outer circumference of another side of the plate 141, a left outer circumference in the illustrated implementation, is located between the third height sensor module 330 and the fourth height sensor module 340 in the left and right directions.

Accordingly, the height sensor modules 310, 320, 330, and 340 can detect height information in different areas. A detailed description thereof will be given later.

The blade motor 142 is coupled to the plate 141 to rotate the plate 141. The blade motor 142 may be coupled to the plate 141 by a member such as a rod (not illustrated). In one implementation, the blade motor 142 may be coupled to the center of the plate 141.

The blade motor 142 may be accommodated in the inner space of the housing 110. Therefore, even when gravel or the like bounces off as the grass is cut, the blade motor 142 is not damaged.

The blade motor 142 may be controlled according to operation information calculated by the control unit 400. Specifically, the blade motor 142 may be controlled by an operation control module 430 of the control unit 400. Also, the blade motor 142 is electrically connected to the control unit 400.

The sub blade 143 substantially performs a role of cutting the grass.

The sub blade 143 is coupled to the plate 141. When the plate 141 is rotated, the sub blade 143 may also be rotated. Accordingly, the grass on the travel path of the lawn mower robot 10 can be cut.

The sub blade 143 may be formed in any shape capable of cutting an object such as grass. In one implementation, the sub blade 143 may be configured in the form of a blade.

The sub blade 143 may extend in one direction. In the illustrated implementation, the sub blade 143 extends in the left and right directions.

The sub blade 143 may extend by a predetermined length l. In the illustrated implementation, the sub blade 143 extends so that an end portion thereof facing each main wheel 121a, 121b, that is, an outer end portion is located on the outer circumference of the plate 141.

In another implementation, the sub blade 143 may extend so that the end portion is located between the outer circumference of the plate 141 and the main wheel 121a, 121b.

However, the end portion of the sub blade 143 is preferably located at an inner side rather than the first height sensor module 310 and the third height sensor module 330, that is, adjacent to the outer circumference of the plate 141.

The sub blade 143 may extend downward, that is, in a direction toward the ground or grass. The height may be determined according to a height of grass desired by the user.

The sub blade 143 may be provided in plurality. The plurality of sub blades 143 may be disposed on both sides of the plate 141 facing the main wheels 121a and 121b.

In the illustrated implementation, the sub blades 143 include a first sub blade 143a and a second sub blade 143b.

The first sub blade 143a is located to be biased toward the first main wheel 121a. The second sub blade 143b is located to be biased toward the second main wheel 121b. That is, the first sub blade 143a is located on the right side and the second sub blade 143b is located on the left side.

In one implementation, the first sub blade 143a extends such that an end portion facing the first main wheel 121a is located between the first height sensor module 310 and the second height sensor module 320. In addition, the second sub blade 143b extends such that an end portion facing the second main wheel 121b is located between the third height sensor module 330 and the fourth height sensor module 340.

Accordingly, the first height sensor module 310 and the third height sensor module 330 can detect height information H1 and H3 of outer sides of the sub blades 143a and 143b, that is, respective areas between the end portions of the sub blades 143a and 143b and the main wheels 121a and 121b.

Also, the second height sensor module 320 and the fourth height sensor module 340 can detect height information H2 and H4 of inner sides of the sub blades 143a and 143b, that is, respective areas between the end portions of the sub blades 143a and 143b and the center of the plate 141.

A detailed description of the process will be given later.

(2) Description of Travel Sensor Unit 200

The travel sensor unit 200 detects travel information related to the driving (traveling, running) of the lawn mower robot 10. The travel sensor unit 200 detects information related to an external environment in which the lawn mower robot 10 operates. As will be described later, the travel information may include image information, distance information, location information, and rotation information.

Various pieces of information detected by the travel sensor unit 200 may be transmitted to the control unit 400, and the control unit 400 may generate control information suitable for situations.

The travel sensor unit 200 may be configured in an arbitrary form, which is capable of detecting information on an external environment or a driving situation of the lawn mower robot 10.

The travel sensor unit 200 may be electrically connected to a battery (not illustrated). Power required for the operation of the travel sensor unit 200 may be supplied by the connection.

The travel sensor unit 200 may be electrically connected to the control unit 400. Each piece of information detected by the travel sensor unit 200 may be transmitted to the control unit 400.

The travel sensor unit 200 includes an image sensor module 210, a distance sensor module 220, a location sensor module 230, and a rotation sensor module 240.

Also, although not illustrated, the travel sensor unit 200 may include a tilt sensor (not illustrated). The tilt sensor (not illustrated) may detect a tilted degree of the lawn mower robot 10 with respect to the ground. In one implementation, the tilt sensor (not illustrated) may be configured as a gyro sensor.

The image sensor module 210 is configured to detect external image information related to one side of the lawn mower robot 10. In one implementation, the image sensor module 210 may be configured to detect image information related to the front side that is a direction in which the lawn mower robot 10 is traveling.

Accordingly, obstacles or the like located on an expected path of the lawn mower robot 10 can be detected based on the image information detected by the image sensor module 210.

The image sensor module 210 may be provided in any form capable of acquiring image information, that is, still images or moving images (videos). In one implementation, the image sensor module 210 may be implemented as a camera, a camcorder, or the like.

The image sensor module 210 may be electrically connected to a travel information reception module 440 of the control unit 400. The image information detected by the image sensor module 210 may be transferred to an image information reception unit 441 and used to calculate operation information.

In the illustrated implementation, the image sensor module 210 is located on a top of the housing 110. The image sensor module 210 may be disposed at any position where image information can be acquired.

The distance sensor module 220 is configured to detect a distance between the lawn mower robot 10 and an arbitrary object outside the lawn mower robot 10. That is, the distance sensor module 220 is configured to detect distance information that is information related to n a distance between the lawn mower robot 10 and the object.

Accordingly, the image sensor module 220 can detect obstacles or the like located on a travel path of the lawn mower robot 10.

The distance sensor module 220 may be configured in any form capable of detecting a distance from an arbitrary object. In one implementation, the distance sensor module 220 may be configured as an ultrasonic sensor, an infrared ray (IR) sensor, a light detection and ranging (LiDAR) sensor, a radio detecting and ranging (RADAR) sensor, a camera (stereo camera), or the like.

The distance sensor module 220 is electrically connected to the travel information reception module 440 of the control unit 400. The distance information detected by the distance sensor module 220 may be transferred to a distance information reception unit 442, and used to calculate operation information.

The distance sensor module 220 is located on the front side of the housing 110.

The distance sensor module 220 may be provided in plurality. In the illustrated implementation, the distance sensor module 220 includes a first distance sensor unit 221, a second distance sensor unit 222, and a third distance sensor unit 223.

The first distance sensor unit 221 may be configured to detect distance information in a preset first direction. To this end, the first distance sensor unit 221 may be located to face the first direction.

In the illustrated implementation, the first direction may be a right side, and the first distance sensor unit 221 may be located on a front right side of the housing 110.

The second distance sensor unit 222 may be configured to detect distance information in a preset second direction. To this end, the second distance sensor unit 222 may be located to face the second direction.

In the illustrated implementation, the second direction indicates the center, and the second distance sensor unit 222 may be located on a front center of the housing 110.

The third distance sensor unit 223 may be configured to detect distance information in a preset third direction. To this end, the third distance sensor unit 223 may be located to face the third direction.

In the illustrated implementation, the third direction indicates the front side, and the third distance sensor unit 223 may be located on a front left side of the housing 110.

The second direction may be located between the first direction and the second direction. In the illustrated implementation, the second direction is the front side, and located between the first direction facing the right side and the second direction facing the left side.

Therefore, the first distance sensor unit 221 detects distance information from an arbitrary object located at the right side of the lawn mower robot 10. Also, the second distance sensor unit 222 detects distance information from an arbitrary object located at the front side of the lawn mower robot 10. Furthermore, the third distance sensor unit 223 detects distance information from an arbitrary object located at the left side of the lawn mower robot 10.

This takes into account that the lawn mower robot 10 generally travels to the front side and to the right or left side with respect to the front side. Accordingly, frequency at which the lawn mower robot 10 collides with an object present on a travel path can be reduced, so that an efficient lawn maintenance work can be performed.

The location sensor module 230 is configured to detect location information related to the lawn mower robot 10. That is, the location sensor module 230 may set an area in which the lawn mower robot 10 performs a task in one coordinate system, and detect the position of the lawn mower robot 10 in the form of coordinate information.

The location sensor module 230 may be configured in any form capable of detecting a position of a currently moving object in a preset manner. In one implementation, the location sensor module 230 may be configured as a Global Positioning System (GPS) sensor.

The location sensor module 230 may be accommodated in a predetermined space defined inside the housing 110. Alternatively, the location sensor module 230 may be located outside the housing 110 to improve reception efficiency.

The location sensor module 230 is electrically connected to the travel information reception module 440 of the control unit 400. The location information detected by the location sensor module 230 may be transferred to a location information reception unit 443 and used to calculate operation information.

The rotation sensor module 240 is configured to detect rotation information related to the number of turns and a rotational direction of the main wheel 121. The rotation sensor module 240 may be provided in the main wheel 121 or the power module 130. This results from that the main wheel 121 and the power module 130 have the same number of turns or revolutions and rotational direction.

Also, the rotation sensor module 240 is configured to detect rotation information related to the number of turns and a rotational direction of the blade 140. The rotation sensor module 240 may be provided in the plate 141 or the blade motor 142. This results from that the blade 141 and the blade motor 142 have the same number of turns or revolutions and rotational direction.

The rotation sensor module 240 may be configured in any form capable of detecting the number of turns or revolutions of a rotating object. In one implementation, the rotation sensor module 240 may be configured as a photo sensor, an encoder sensor, or the like.

The rotation sensor module 240 may be provided in plurality. In the illustrated implementation, the rotation sensor module 240 includes totally three modules, namely, a first rotation sensor module 241, a second rotation sensor module 242, and a third rotation sensor module 243.

This results from that the main wheels 121 and the power modules 130 are two in number and the plate 141 and the blade motor 142 are one in number, respectively.

The first rotation sensor module 241 is located adjacent to the first main wheel 121a or the first power module 131. The first rotation sensor module 241 may detect the number of turns, rotational direction, or rotational speed of the first main wheel 121a or the first power module 131.

The second rotation sensor module 242 is located adjacent to the second main wheel 121b or the second power module 132. The second rotation sensor module 242 may detect the number of turns, rotational direction, or rotational speed of the second main wheel 121b or the second power module 132.

The third rotation sensor module 243 is located adjacent to the plate 141 or the blade motor 142. The third rotation sensor module 243 may detect the number of turns, rotational direction, or rotational speed of the plate 141 or the blade motor 142.

### 3. Description of Height Sensor Unit 300 According to Implementation

Referring to FIGS. 1 to 6, the lawn mower robot 10 according to the implementation disclosed herein includes a height sensor unit 300.

The height sensor unit 300 is located on the lower side of the housing 110 and is configured to detect height information H1, H2, H3, H4 that is a distance between the lower side of the housing 110 and the ground or grass. As will be described later, the height information H1, H2, H3, H4 may be sorted into first height information H1, second height information H2, third height information H3, and fourth height information H4 according to a sensing subject.

Specifically, when there is no grass on the ground, the height sensor unit 300 detects height information H1, H2, H3, H4 between the lower side of the housing 110 and the ground. In addition, when there is grass on the ground, the height sensor unit 300 detects height information H1, H2, H3, H4 between the lower side of the housing 110 and a top of the grass.

The height sensor unit 300 may continuously detect a plurality of pieces of height information H1, H2, H3, and H4. That is, the height sensor unit 300 may detect a plurality of pieces of height information H1, H2, H3, and H4 regarding a specific area.

The plurality of detected height information H1, H2, H3, and H4 are transmitted to the control unit 400. The control unit 400 may calculate operation information by using height information H1, H2, H3, H4 having a minimum value among the plurality of detected height information H1, H2, H3, and H4.

This results from that a portion where a signal emitted by the height sensor unit 300 is reflected is the top of the grass and thus an amount of reflected signals may vary depending on density or length of the grass.

Therefore, it is preferable to detect more height information H1, H2, H3, H4 used as basis data for calculating the operation information. The height sensor unit 300 may continuously repeat the detecting process until the detected number of height information H1, H2, H3, H4 of the specific area exceeds a predetermined number. In one implementation, the predetermined number may be 100.

The height sensor unit 300 is located on a lower front side of the housing 110. Specifically, the height sensor unit 300 is located at the front of the blade 140. In the illustrated implementation, the height sensor unit 300 is located between the sub wheel 122 and the blade 140.

Alternatively, the height sensor unit 300 may be located at the front of the sub wheel 122.

The arrangement is for detecting height information regarding an area, in which a lawn mowing task has not been carried out yet, in a path on which the lawn mower robot 10 is to travel, that is, in the travel path of the lawn mower robot 10.

The height sensor unit 300 is electrically connected to the control unit 400. The height information H1, H2, H3, and H4 detected by the height sensor unit 300 is transmitted to the control unit 400. The control unit 400 calculates operation information using the transmitted height information.

Also, the height sensor unit 300 is electrically connected to a battery (not illustrated). Power required for the operation of the height sensor unit 300 may be supplied by the battery (not illustrated).

The height sensor unit 300 may be configured in any form capable of detecting a distance from another member. In one implementation, the height sensor unit 300 may be configured as a sound wave sensor, an optical sensor, an ultrasonic sensor, an infrared (IR) sensor, a light detection and ranging (LiDAR) sensor, a radio detecting and ranging (RADAR) sensor, a stereo camera sensor, a time of light (ToF) sensor, etc.

The height sensor unit 300 may be provided in plurality. The plurality of height sensor units 300 may be disposed to be spaced apart from one another in one direction. Accordingly, each height sensor unit 300 may detect height information H1, H2, H3, and H4 related to a different area.

In the illustrated implementation, the height sensor unit 300 may include four modules, including first to fourth height sensor modules 310, 320, 330, and 340. The number of height sensor units 300 may change.

The first to fourth height sensor modules 310, 320, 330, and 340 may be disposed to be spaced apart from one another in a direction in which the main wheels 121a and 121b face each other, namely, in the left and right directions in the illustrated implementation.

The first height sensor module 310 and the second height sensor module 320 may be located to be adjacent to the first main wheel 121a. In the illustrated implementation, the first height sensor module 310 and the second height sensor module 320 are located to be biased to the right.

The third height sensor module 330 and the fourth height sensor module 340 may be located to be adjacent to the second main wheel 121b. In the illustrated implementation, the third height sensor module 330 and the fourth height sensor module 340 are located to be biased to the left.

The first height sensor module 310 of the plurality of height sensor modules 310, 320, 330, and 340 is located at the outermost side in one direction. In the illustrated implementation, the first height sensor module 310 is located at the rightmost side.

The first height sensor module 310 is located between the first main wheel 121a and the right outer circumference of the plate 141. In other words, the first height sensor module 310 is located between an end portion of the first sub blade 143a and the first main wheel 121a in the left and right directions.

Accordingly, the first height sensor module 310 may detect height information H1 at an outer side of the end portion of the first sub blade 143a facing the first main wheel 121a, namely, in an area located far from the center of the plate 141 based on the end portion of the first sub blade 143a.

In one implementation, the first height sensor module 310 may detect height information H1 in an area between the end portion of the first sub blade 143a and the first main wheel 121a. The area in which the first height sensor module 310 detects the height information may be defined as a first area A1.

In the following description, the height information H1 detected by the first height sensor module 310 is referred to as “first height information H1”.

The second height sensor module 320 is located between the first height sensor module 310 and the third height sensor module 330. In the illustrated implementation, the second height sensor module 320 is located on the left side of the first height sensor module 310 and on the right side of the center of the plate 141.

The second height sensor module 320 may be disposed to at least partially overlap the plate 141 in the front and rear directions. In the illustrated implementation, the second height sensor module 320 is disposed to overlap the plate 141 in the front and rear directions.

In other words, the second height sensor module 320 is disposed to face the first height sensor module 310 with interposing a virtual tangent line of the outer circumference of the plate 141 in one direction (i.e., right direction).

Accordingly, the second height sensor module 320 can detect height information H2 in an area between the outer circumference of the plate 141 in the one direction (i.e., the right direction) and the center of the plate 141.

In other words, when the first sub blade 143a is disposed perpendicularly to the traveling direction, the second height sensor module 320 may detect the height information in an area between both end portions of the first sub blade 143a in both directions in which the first sub blade 143a extends.

The area in which the second height sensor module 320 detects the height information H2 may be defined as a second area A2.

In the following description, the height information H2 detected by the second height sensor module 320 is referred to as “second height information H2”.

The third height sensor module 330 of the plurality of height sensor modules 310, 320, 330, and 340 is located at the outermost side in another direction. In the illustrated implementation, the third height sensor module 330 is located at the leftmost side.

The third height sensor module 330 is located between the second main wheel 121b and the left outer circumference of the plate 141. In other words, the third height sensor module 330 is located between an end portion of the second sub blade 143b and the second main wheel 121b in the left and right directions.

Accordingly, the third height sensor module 330 may detect height information H3 at an outer side of the end portion of the second sub blade 143b facing the second main wheel 121b, namely, in an area located far from the center of the plate 141 based on the end portion of the second sub blade 143b.

In one implementation, the third height sensor module 330 may detect height information H3 in an area between the end portion of the second sub blade 143b and the second main wheel 121b.

The area in which the third height sensor module 330 detects the height information may be defined as a third area A3.

In the following description, the height information H3 detected by the third height sensor module 330 is referred to as “third height information H3”.

The fourth height sensor module 340 is located between the second height sensor module 320 and the third height sensor module 330. In the illustrated implementation, the fourth height sensor module 340 is located on the right side of the third height sensor module 330 and on the left side of the center of the plate 141.

The fourth height sensor module 340 may be disposed to at least partially overlap the plate 141 in the front and rear directions. In the illustrated implementation, the fourth height sensor module 340 is disposed to overlap the plate 141 in the front and rear directions.

In other words, the fourth height sensor module 340 is disposed to face the third height sensor module 330 with interposing a virtual tangent line of the outer circumference of the plate 141 in another direction (i.e., left direction).

Accordingly, the fourth height sensor module 340 can detect height information H4 in an area between the outer circumference of the plate 141 in the another direction (i.e., the left direction) and the center of the plate 141.

In other words, when the second sub blade 143b is disposed perpendicularly to the traveling direction, the fourth height sensor module 340 may detect the height information H4 in an area between both end portions of the second sub blade 143b in both directions in which the second sub blade 143a extends.

The area in which the fourth height sensor module 340 detects the height information H4 may be defined as a fourth area A4.

In the following description, the height information H4 detected by the fourth height sensor module 340 is referred to as “fourth height information H4”.

As described above, the first and third height sensor modules 310 and 330 are located at an outer side rather than the second and fourth height sensor modules 320 and 340, with respect to the center of the plate 141.

Accordingly, the first and third height sensor modules 310 and 330 may be referred to as “outer height sensor modules”. Likewise, the second and fourth height sensor modules 320 and 340 may be referred to as “inner height sensor modules”.

Similarly, the first and third height information H1 and H3 may be referred to as “outer height information”, and the second and fourth height information H2 and H4 may be referred to as “inner height information”.

### 4. Description of Control Unit 400 According to Implementation

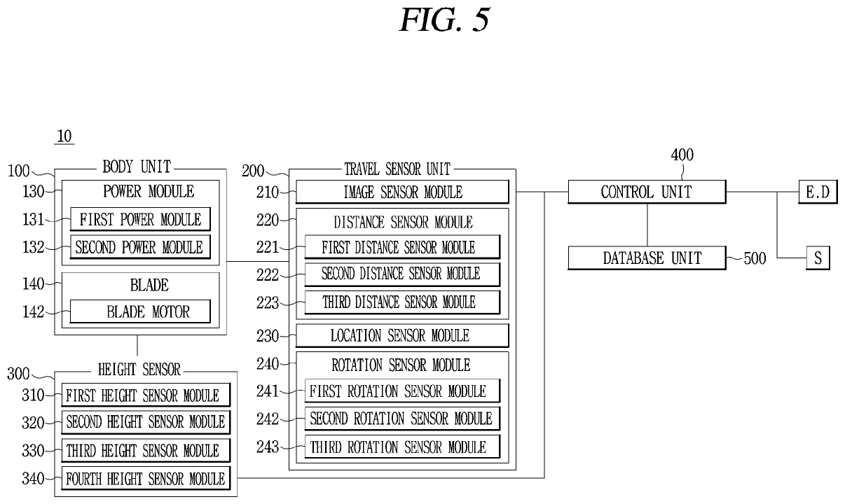

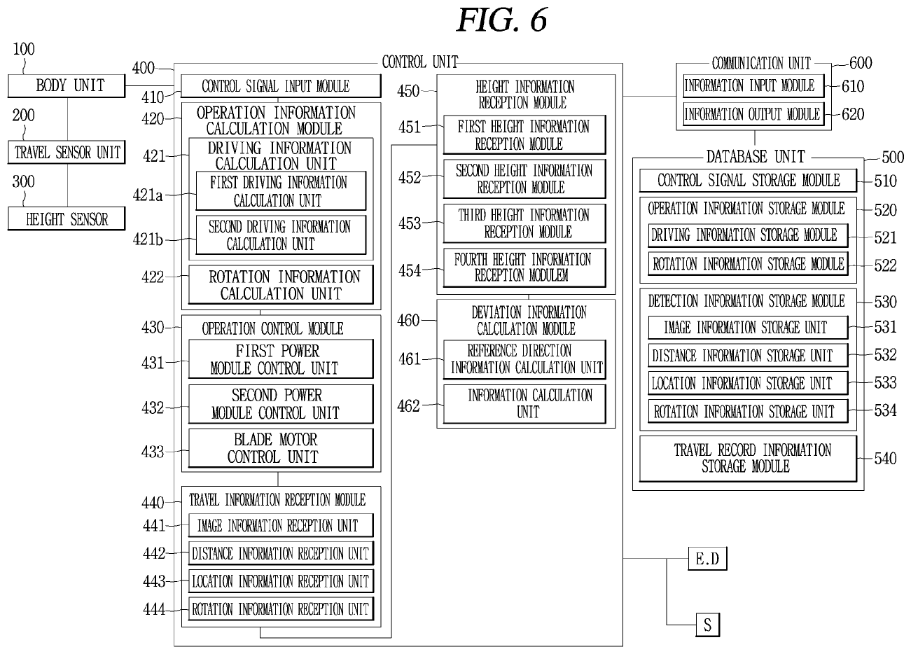

Referring to FIGS. 5 and 6, the lawn mower robot 10 according to the implementation disclosed herein includes the control unit 400.

The control unit 400 receives a control signal from a user and calculates operation information for operating the lawn mower robot 10. The calculated operation information is utilized to control the power module 130 and the blade motor 142.

The control unit 400 may receive travel information detected by the travel sensor unit 200. The control unit 400 is electrically connected to the travel sensor unit 200.

The control unit 400 may receive the height information H1, H2, H3, H4 detected by the height sensor unit 300. The control unit 400 is electrically connected to the height sensor unit 300.

The control unit 400 may calculate operation information using the received control signal or detection information. In addition, the control unit 400 may control each component, specifically, the power module 130 and the blade motor 142 of the lawn mower robot 10 according to the calculated operation information. The control unit 400 is electrically connected to the power module 130 and the blade motor 142.

The control unit 400 is electrically connected to the database unit 500. The control signal input by the user, the travel information detected by the travel sensor unit 200, the height information H1, H2, H3, H4 detected by the height sensor unit 300, and various information calculated by the control unit 400 may be stored in the database unit 500.

Various modules and units of the control unit 400 to be described later may be electrically connected to one another. Accordingly, information input to one module or unit or information calculated by one module or unit may be transferred to another module or unit.

The control unit 400 may be provided in any form capable of inputting, outputting, and calculating information. In one implementation, the control unit 400 may be configured as a microprocessor, a central processing unit (CPU), a printed circuit board (PCB), or the like.

The control unit 400 is located in a predetermined space defined inside the housing 110. The control unit 400 may be hermetically accommodated in the space so as not to be affected by external moisture and the like.

The control unit 400 includes a control signal input module 410, an operation information calculation module 420, an operation control module 430, a travel information reception module 440, a height information reception module 450, and a deviation information calculation module 460.

The control signal input module 410 receives a control signal which is input by a user for operating the lawn mower robot 10. The control signal may include a signal related to the travel of the lawn mower robot 10 and a signal related to the rotation of the blade 140.

The user may input such a control signal through a terminal or the like. In one implementation, the terminal may be a smart phone or the like.

In another implementation, the user may input a control signal through an input interface (not illustrated), such as a button, provided on the lawn mower robot 10. In the implementation, the control signal input module 410 may be electrically connected to the input interface (not illustrated).

The control signal input to the control signal input module 410 is transmitted to the operation information calculation module 420. The control signal input to the control signal input module 410 may also be transmitted to a control signal storage module 510 of the database unit 500.

The operation information calculation module 420 calculates operation information for operating the lawn mower robot 10.

The operation information calculation module 420 may calculate operation information by using a control signal input through the control signal input module 410 or deviation information calculated by the deviation information calculation module 460.

The operation information may include information related to whether the power module 130 rotates, a rotational speed, and a rotational direction. The information may be referred to as driving information.

The operation information calculation module 420 may calculate the operation information (i.e., driving information) as any one of first operation information, second operation information, and third operation information.

The first operation information may be operation information for rotating the first power module 131 faster than the second power module 132. The second operation information may be information for rotating the second power module 132 faster than the first power module 131. The third operation information may be information for rotating the first power module 131 and the second power module 132 at the same speed.

When the operation information calculation module 420 calculates the first operation information, the lawn mower robot 10 moves in a direction opposite to the first power module 131, that is, to the left in the illustrated implementation.

When the operation information calculation module 420 calculates the second operation information, the lawn mower robot 10 moves in a direction opposite to the second power module 132, that is, to the right in the illustrated implementation.

When the operation information calculation module 420 calculates the third operation information, the lawn mower robot 10 travels straight in a currently traveling direction.

The operation information may include information related to whether the blade motor 142 rotates, a rotational speed, and a rotational direction. The information may be referred to as rotation information.

The operation information calculated by the operation information calculation module 420 is transmitted to the operation control module 430. The operation information calculated by the operation information calculation module 420 is also transmitted to an operation information storage module 520 of the database unit 500.

The operation information calculation module 420 includes a driving information calculation unit 421 and a rotation information calculation unit 422.

The driving information calculation unit 421 calculates the driving information. The driving information calculation unit 421 may calculate driving information by using a control signal input through the control signal input module 410 or reference direction information and deviation information calculated by the deviation information calculation module 460.

The driving information calculated by the driving information calculation unit 421 may include information related to rotation or non-rotation, a rotational speed, and a rotational direction of the first power module 131 and the second power module 132.

In detail, the first power module 131 and the second power module 132 may be rotated in a preset first rotational direction. In one implementation, the first rotational direction may be a direction in which the lawn mower robot 10 travels forward, that is, a counterclockwise direction when viewed from the left side of the lawn mower robot 10.

In addition, the first power module 131 and the second power module 132 may be rotated in a preset second rotational direction opposite to the first rotational direction. In one implementation, the second rotational direction may be a direction in which the lawn mower robot 10 moves reversely, that is, a clockwise direction when viewed from the left side of the lawn mower robot 10.

That is, the first power module 131 and the second power module 132 may be rotated in any one of the first rotational direction and the second rotational direction.

As described above, the first power module 131 and the second power module 132 may be controlled independently.

Accordingly, the driving information may be classified into first driving information that is information related to rotation or non-rotation, rotational speed, and rotational direction of the first power module 131, and second driving information that is information related to rotation or non-rotation, rotational speed, and rotational direction of the second power module 132.

Accordingly, the lawn mower robot 10 may move straight forward, straight backward, straight forward or backward to the left, or straight forward or backward to the right, and may rotate according to the first driving information and the second driving information calculated by the driving information calculation unit 421.

The driving information calculated by the driving information calculation unit 421, specifically, the first driving information and the second driving information are transmitted to the operation control module 430 and the operation information storage module 520.

The rotation information calculation unit 422 calculates the rotation information. The rotation information calculation unit 422 may calculate rotation information using a control signal input through the control signal input module 410.

The rotation information may include information related to rotation or non-rotation, rotational speed, and rotational direction of the blade motor 142.

Accordingly, the blade motor 142 and the plate 141 connected thereto may be rotated or stopped according to the rotation information calculated by the rotation information calculation unit 422.

The rotation information calculated by the rotation information calculation module 422 is also transmitted to the operation control module 430 and the operation information storage module 520.

The operation control module 430 controls the power module 130 according to the operation information calculated by the operation information calculation module 420. The operation control module 430 is electrically connected to the operation information calculation module 420.

The operation control module 430 includes a first power module control unit 431, a second power module control unit 432, and a blade motor control unit 433.

The first power module control unit 431 controls the first power module 131 according to the calculated first driving information. The first power module control unit 431 is electrically connected to the first power module 131.

The second power module control unit 432 controls the second power module 132 according to the calculated second driving information. The second power module control unit 432 is electrically connected to the second power module 132.

The first power module control unit 431 and the second power module control unit 432 may independently control the first power module 131 and the second power module 132. Therefore, the first power module 131 and the second power module 132 can be operated independently of each other.

The blade motor control unit 433 controls the blade motor 142 according to the calculated rotation information. The blade motor control unit 433 is electrically connected to the blade motor 142.

The travel information reception module 440 receives each information detected by the travel sensor unit 200. The travel information reception module 440 is electrically connected to the travel sensor unit 200.

Each information transmitted to the travel information reception module 440 is utilized as basic data for the operation information calculation module 420 to calculate the operation information. The travel information reception module 440 is electrically connected to the operation information calculation module 420.

The travel information reception module 440 is electrically connected to the database unit 500. Each information detected by the travel sensor unit 200 may be transmitted to the database unit 500 through the travel information reception module 440.

The travel information reception module 440 includes an image information reception unit 441, a distance information reception unit 442, a location information reception unit 443, a rotation information reception unit 444, and a tilt information reception unit 445.

The image information reception unit 441 receives image information detected by the image sensor module 210. The image information reception unit 441 is electrically connected to the image sensor module 210.

The image information may be utilized to calculate whether there is an obstacle such as an arbitrary object on a path on which the lawn mower robot 10 travels.

The image information may be provided to the user in the form of visualization information, so that the user can recognize a current situation of a task. In one implementation, the image information received by the image information reception unit 441 may be delivered to an external device E.D in the form of visualization information.

In the implementation, the image information reception unit 441 may be electrically connected to the external device E.D.

In one implementation, the image information reception unit 441 and the external device E.D may be connected in a manner such as Wi-Fi or Bluetooth.

The image information received by the image information reception unit 441 is transmitted to a detection information storage module 530 of the database unit 500. The image information reception unit 441 is electrically connected to an image information storage unit 531.

The distance information reception unit 442 receives distance information detected by the distance sensor module 220. The distance information reception unit 442 is electrically connected to the distance sensor module 220.

In the illustrated implementation, the distance information detected by the distance sensor module 220 may be classified into three pieces of information.

That is, the distance information may be classified into first distance information in a first direction, second distance information in a second direction, and third distance information in a third direction. The distance sensor module 220 may receive all of the first to third distance information.

The first to third distance information may be used to calculate information related to a direction in which a distance between the lawn mower robot 10 and an arbitrary object is the shortest.

Each distance information received by the distance information reception unit 442 is transmitted to the operation information calculation module 420. The distance information calculation unit 442 is electrically connected to the operation information calculation module 420.

Each distance information received by the distance information reception unit 442 is transmitted to the detection information storage module 530. The distance information reception unit 442 is electrically connected to a distance information storage unit 532.

The location information reception unit 443 receives location information detected by the location sensor module 230. The location information reception unit 443 is electrically connected to the location sensor module 230.

The location information received by the location information reception unit 443 is utilized to accurately calculate the location of the lawn mower robot 10.

The location information received by the location information reception unit 443 is transmitted to the operation information calculation module 420. The location information reception unit 443 is electrically connected to the operation information calculation module 420.

The location information received by the location information reception unit 443 is transmitted to a location information storage unit 533 of the database unit 500. The location information reception unit 443 is electrically connected to the location information storage unit 533.

The rotation information reception unit 444 receives rotation information detected by the rotation sensor module 240.

Specifically, the rotation information reception unit 444 receives rotation information detected by the first to third rotation sensor modules 241, 242, and 243.

As described above, the rotation information detected by the first rotation sensor module 241 is information related to the rotation of the first power module 131. The rotation information detected by the second rotation sensor module 242 is information related to the rotation of the second power module 132, and the rotation information detected by the third rotation sensor module 243 is information related to the rotation of the blade motor 142.

The rotation information received by the rotation information reception unit 444 is utilized to calculate information related to the travel of the lawn mower robot 10. In addition, the rotation information is used to calculate information related to the rotation of the blade 140 for the lawn mower robot 10 to perform a lawn mowing operation.

The rotation information received by the rotation information reception unit 444 is transmitted to the operation information calculation module 420. The rotation information reception unit 444 is electrically connected to the operation information calculation module 420.

The rotation information received by the rotation information reception unit 444 is transmitted to a rotation information storage unit 534 of the database unit 500. The rotation information reception unit 444 is electrically connected to the rotation information storage unit 534.

The height information reception module 450 receives the height information H1, H2, H3, H4 detected by the height sensor unit 300. The height information reception module 450 is electrically connected to the height sensor unit 300.

Specifically, the height information reception module 450 receives the first to fourth height information H1, H2, H3, and H4 detected by the first to fourth height sensor modules 310, 320, 330, and 340.

Each of the first to fourth height information H1, H2, H3, and H4 received by the height information reception module 450 are transmitted to the deviation information calculation module 460 to be used as basis data for calculating deviation information. The height information reception module 450 and the deviation information calculation module 460 are electrically connected to each other.

The height information reception module 450 includes a first height information reception module 451, a second height information reception module 452, a third height information reception module 453, and a fourth height information reception module 454.

The first height information reception module 451 receives the first height information H1. The first height information reception module 451 is electrically connected to the first height sensor module 310.

The second height information reception module 452 receives the second height information H2. The second height information reception module 452 is electrically connected to the second height sensor module 320.

The third height information reception module 453 receives the third height information H3. The third height information reception module 453 is electrically connected to the third height sensor module 330.

The fourth height information reception module 454 receives the fourth height information H4. The fourth height information reception module 454 is electrically connected to the fourth height sensor module 340.

The deviation information calculation module 460 calculates deviation information by using the received first to fourth height information H1, H2, H3, and H4. The deviation information calculated by the deviation information calculation module 460 is transferred to the operation information calculation module 420 to be used to calculate the operation information.

The deviation information calculation module 460 is electrically connected to the operation information calculation module 420.

Also, the deviation information calculated by the deviation information calculation module 460 is transmitted to the database unit 500. The deviation information calculation module 460 is electrically connected to a travel record information storage module 540.

In order for the deviation information calculation module 460 to calculate the deviation information, a reference for determining whether the lawn mower robot 10 deviates from (is biased with respect to) a preset path is required.

Accordingly, the deviation information calculation module 460 may also calculate reference direction information, which is to serve as the reference.

The deviation information calculation module 460 includes a reference direction information calculation unit 461 and a deviation information calculation unit 462.

The reference direction information calculation unit 461 calculates reference direction information serving as a reference for calculating whether the running lawn mower robot 10 has deviated from the travel path.

Specifically, in order to calculate a direction in which the lawn mower robot 10 deviates during travel, a reference for determining whether such deviation occurs is required.

Accordingly, the reference direction information calculation unit 461 calculates, as the reference direction information, a path located at one side or another side of the lawn mower robot 10 which is traveling, namely, the right or left side in the illustrated implementation.

The reference direction information may be calculated as one side or another side. In other words, the reference direction information may be calculated as any one of the right and left sides of the lawn mower robot 10 which is traveling.

The reference direction information may be determined to be a direction in which a current travel path of the lawn mower robot 10 overlaps a path that the lawn mower robot 10 has passed while performing the lawn mowing task.

That is, the lawn mower robot 10 may travel a path determined to partially overlap a path it has passed. Accordingly, the lawn mowing operation for grass that exists in an area where the lawn mower robot 10 travels can be performed without exception.

In this case, a path on which the lawn mower robot 10 is currently traveling may overlap a previously passed path at one side (i.e., the right side) or another side (i.e., the left side).

When the path on which the lawn mower robot 10 is traveling overlaps the previously passed path at the one side (i.e., the right side), the reference direction information is calculated as the right side. When the path on which the lawn mower robot 10 is traveling overlaps the previously passed path at the another side (i.e., the left side), the reference direction information is calculated as the left side.

The reference direction information may be calculated based on input control signal. Also, the reference direction information may be calculated based on travel record information.

For example, a description will be given under the assumption that the lawn mower robot 10 moves straight in one direction, rotates perpendicularly to one side (i.e., to the right) twice, and then continues to travel.

In this case, a path through which the lawn mower robot 10 has already passed is located at the one side (i.e., the right side) of a path on which the lawn mower robot 10 is traveling. Accordingly, the reference direction information calculation unit 461 may calculate the reference direction information as the right side.

As another example, a description will be given under the assumption that the lawn mower robot 10 moves straight in one direction, rotates perpendicularly to another side (i.e., to the left) twice, and then continues to travel.

In this case, a path through which the lawn mower robot 10 has already passed is located at the another side (i.e., the left side) of a path on which the lawn mower robot 10 is traveling. Accordingly, the reference direction information calculation unit 461 may calculate the reference direction information as the left side.

The reference direction information calculated by the reference direction information calculation unit 461 is transmitted to the deviation information calculation unit 462. The reference direction information calculation unit 461 and the deviation information calculation unit 462 are electrically connected to each other.

The deviation information calculation unit 462 calculates deviation information by using the detected height information H1, H2, H3, and H4, the calculated reference direction information, and preset reference height information R.H.

The deviation information may include information related to whether or not the lawn mower robot 10 being traveling has deviated from a preset travel path and information related to a deviation direction. The deviation information may be calculated by using the reference direction information calculated by the reference direction information calculation unit 461.

As described above, the lawn mower robot 10 according to the implementation includes the plurality of height sensor modules 310, 320, 330, and 340. The first and second height sensor modules 310 and 320 are located on one side (i.e., the right side) of the lawn mower robot 10, and the third and fourth height sensor modules 330 and 340 are located on another side (i.e., the left side) of the lawn mower robot 10.

The arrangement of the first to fourth height sensor modules 310, 320, 330, and 340 is intended to vary the height information H1, H2, H3, and H4 detected according to the calculated reference direction information.

The height information H1, H2, H3, H4 for calculating the deviation information may be determined, from among the height information H1, H2, H3, H4 detected by the plurality of height sensor modules 310, 320, 330, 340, according to the reference direction information.

Specifically, when the reference direction information is calculated as the one side (i.e., the right side), the deviation information is calculated by using the first and second height information H1 and H2 detected by the first and second height sensor modules 310 and 320, which are located on the one side (i.e., the right side), of the plurality of height sensor modules 310, 320, 330, and 340.

In addition, when the reference direction information is calculated as the another side (i.e., the left side), the deviation information is calculated by using the third and fourth height information H3 and H4 detected by the third and fourth height sensor modules 330 and 340, which are located on the another side (i.e., the left side), of the plurality of height sensor modules 310, 320, 330, and 340.

The deviation information calculation unit 462 calculates the deviation information by comparing the first and second height information H1 and H2 or the third and fourth height information H3 and H4 selected using the reference direction information with preset reference height information R.H.

The preset reference height information R.H may be defined as distance information between the lower side of the housing 110 and the ground when there is no grass or gravel in the area where the lawn mower robot 10 is located. In other words, the preset reference height information R.H may be defined as height information of the lower side of the housing 110 based on a flat ground.

That is, the preset reference height information R.H is a distance at which the lower side of the housing 110 is maximally spaced apart from the ground when there is no arbitrary object on the ground. The reference height information R.H may be preset. That is, the reference height information R.H may be set and stored when the lawn mower robot 10 is manufactured, or may be set or reset by a user.

The deviation information calculation unit 462 may calculate the deviation information as any one of first deviation information, second deviation information, and third deviation information.

The first deviation information indicates that the travel path of the lawn mower robot 10 is biased to one side (i.e., the right side). The second deviation information indicates that the travel path of the lawn mower robot 10 is biased to another side (i.e., the left side). The third deviation information indicates that the travel path of the lawn mower robot 10 is directed to still another side (i.e., the front side).

In particular, the third deviation information may indicate that the lawn mower robot 10 is moving along a preset travel path.

A process in which the deviation information calculation unit 462 calculates deviation information will be described in more detail as follows.

Hereinafter, an exemplary case where the reference deviation information calculation unit 461 calculates the reference direction information as one side (i.e., the right side) will be first described.

The deviation information calculation unit 462 selects first height information H1 and second height information H2, which are height information related to a first area A1 and a second area A2 located at the one side (i.e., the right side), from among the plurality of height information H1, H2, H3, and H4 received.

First, the deviation information calculation unit 462 compares the first height information H1 related to the first area A1 that is an area located at an outer side with the second height information H2 related to the second area A2 that is an area located at an inner side.

When the first height information H1 and the second height information H2 are the same, it may be determined that the first area A1 and the second area A2 are all located on a previously passed path or on a current travel path.

The deviation information calculation unit 462 compares the first height information H1 or the second height information H2 with the reference height information R.H.

When the first height information H1 and the second height information H2 are equal to or higher than (or the same as) the reference height information R.H, it may be understood that both the first area A1 and the second area A2 are located on the previously passed path.

When both the first area A1 and the second area A2 are located on the previously passed path, it may be understood that the path on which the lawn mower robot 10 is traveling excessively overlaps the previously passed path.

Accordingly, the deviation information calculation unit 462 calculates the first deviation information indicating that the lawn mower robot 10 is biased to the one side (i.e., the right side).

When the first height information H1 and the second height information H2 are lower than the reference height information R.H, it may be understood that both the first area A1 and the second area A2 are located on the path that the lawn mower robot 10 is currently traveling.

When both the first area A1 and the second area A2 are located on the current travel path, it may be understood that the path on which the lawn mower robot 10 is traveling does not excessively overlap or does not overlap the previously passed path.

Accordingly, the deviation information calculation unit 462 calculates the second deviation information indicating that the lawn mower robot 10 is biased to the another side (i.e., the right side).

When the first height information H1 exceeds the second height information H2 and is equal to or higher than the reference height information R.H, it may be understood that the first area A1 located at the outer side is located on the previously passed path and the second area A2 located at the inner side is located on the current travel path.

In this case, it may be understood that the path on which the lawn mower robot 10 is traveling overlaps the previously passed path at an appropriate level.

Accordingly, the deviation information calculation unit 462 calculates the third deviation information indicating that the lawn mower robot 10 is traveling toward the still another side (i.e., the right side) along the preset path.

Hereinafter, an exemplary case where the reference deviation information calculation unit 461 calculates the reference direction information as another side (i.e., the left side) will be described.

The deviation information calculation unit 462 selects the third height information H3 and the fourth height information H4, which are height information related to a third area A3 and a fourth area A4 located at the another side (i.e., the left side), from among the plurality of height information H1, H2, H3, and H4 received.

First, the deviation information calculation unit 462 compares the third height information H3 related to the third area A3 that is an area located at an outer side with the fourth height information H4 related to the fourth area A4 that is an area located at an inner side.

When the third height information H3 and the fourth height information H4 are the same, it may be determined that the third area A3 and the fourth area A4 are all located on a previously passed path or on a current travel path.

The deviation information calculation unit 462 compares the third height information H3 or the fourth height information H4 with the reference height information R.H.

When the third height information H3 and the fourth height information H4 are equal to or higher than (or the same as) the reference height information R.H, it may be understood that both the third area A3 and the fourth area A4 are located on the previously passed path.

When both the third area A3 and the fourth area A4 are located on the previously passed path, it may be understood that the path on which the lawn mower robot 10 is traveling excessively overlaps the previously passed path.

Accordingly, the deviation information calculation unit 462 calculates the second deviation information indicating that the lawn mower robot 10 is biased to the another side (i.e., the right side).

When the third height information H3 and the fourth height information H4 are lower than the reference height information R.H, it may be understood that both the third area A3 and the fourth area A4 are located on the path that the lawn mower robot 10 is currently traveling.

When both the third area A3 and the fourth area A4 are located on the current travel path, it may be understood that the path on which the lawn mower robot 10 is traveling does not excessively overlap or does not overlap the previously passed path.

Accordingly, the deviation information calculation unit 462 calculates the first deviation information indicating that the lawn mower robot 10 is biased to the one side (i.e., the right side).

When the third height information H3 exceeds the fourth height information H4 and is equal to or higher than the reference height information R.H, it may be understood that the third area A3 located at the outer side is located on the previously passed path and the fourth area A4 located at the inner side is located on the current travel path.

In this case, it may be understood that the path on which the lawn mower robot 10 is traveling overlaps the previously passed path at an appropriate level.

Accordingly, the deviation information calculation unit 462 calculates the third deviation information indicating that the lawn mower robot 10 is traveling toward the still another side (i.e., the right side) along the preset path.

The above contents are shown in a table as follows.

TABLE 1

| Reference | | | |
|---|---|---|---|
| direction | | | |
| information | Calculated deviation information | | |
| One side | H1 = H2 = R · H | H1 = H2 < R · H | H1 = R · H > H2 |
| (i.e., right side) | First deviation | Second deviation | Third deviation |
| | information | information | information |
| Another side | H3 = H4 = R · H | H3 = H4 < R · H | H3 = R · H > H4 |
| (i.e., left side) | Second deviation | First deviation | Third deviation |
| | information | information | information |

The deviation information calculated by the deviation information calculation unit 462 is transmitted to the operation information calculation module 420. The deviation information calculation unit 462 is electrically connected to the operation information calculation module 420.

The operation information calculation module 420 may calculate any one of first operation information, second operation information, and third operation information according to the transmitted deviation information. A detailed description of the process will be given later.

The deviation information calculated by the deviation information calculation unit 462 is transmitted to the travel record information storage module 540. The deviation information calculation unit 462 is electrically connected to the travel record information storage module 540.

### 5. Description of Database Unit 500 and Communication Unit 600 According to Implementation

Referring to FIGS. 5 and 6, the lawn mower robot 10 according to the implementation disclosed herein includes the database unit 500.

The database unit 500 stores a control signal input by a user. In addition, the database unit 500 receives and stores operation information, travel information, height information, and deviation information calculated by the control unit 400.

The database unit 500 is electrically connected to the control unit 400. The control signal, travel information, and height information received by the control unit 400 may be transmitted to the database unit 500. Also, the operation information and the deviation information calculated by the control unit 400 may be transmitted to the database unit 500.

The database unit 500 cumulatively stores each received signal and information. In one implementation, the database unit 500 may store the signals and information by mapping the same to an operation time of the lawn mower robot 10 and an environment.

That is, each information related to a task performed by the lawn mower robot 10 and an area in which the lawn mower robot 10 performs the task at a specific time may be stored in a mapping manner.

Various modules and units of the database unit 500 to be described later may be electrically connected to one another. Therefore, each information stored in each module and unit of the database unit 500 can be transmitted to other modules and units.

The database unit 500 may be configured in any form capable of inputting, outputting, and storing information. In one implementation, the database unit 500 may be configured as HDD, SDD, a micro SD car, an SD card, a USB memory, and the like.

The database unit 500 is located in a predetermined space defined inside the housing 110. The database unit 500 may be hermetically accommodated in the space so as not to be affected by external moisture and physical impact.

The database unit 500 includes a control signal storage module 510, an operation information storage module 520, a detection information storage module 530, and a travel record information storage module 540.

The control signal storage module 510 stores a control signal input to the control signal input module 410. The control signal storage module 510 is electrically connected to the control signal input module 410.

The control signal stored in the control signal storage module 510 may be mapped to environment information in which the lawn mower robot 10 operates and then stored. Accordingly, the control signal storage module 510 may sort and store a control signal with respect to a task desired by the user according to a specific environment.

The control signals stored in the control signal storage module 510 may be utilized when the user wants to perform tasks automatically. That is, when an environment of a time for which the lawn mower robot 10 operates is similar to a specific environment with which the stored control signal is mapped, the lawn mower robot 10 may be controlled according to the corresponding control signal.

The operation information storage module 520 stores operation information calculated by the operation information calculation module 420. The operation information storage module 520 is electrically connected to the operation information calculation module 420.

The operation information storage module 520 may store operation information according to a specific control signal. The operation information storage module 520 is electrically connected to the control signal storage module 510.

The operation information stored in the operation information storage module 520 may be mapped with environment information in which the lawn mower robot 10 operates and a control information for operating the lawn mower robot 10 and then stored. Accordingly, the operation information storage module 520 may classify and store operation information on a task to be performed by the lawn mower robot 10 according to a specific environment and a specific control signal.

As described above, the operation information includes driving information and rotation information. Accordingly, the driving information and the rotation information may be classified and stored in the operation information storage module 520.

The driving information stored in the operation information storage module 520 may be utilized when the user wants to perform a task automatically. That is, when an environment of a time for which the lawn mower robot 10 operates or a control signal for operating the lawn mower robot 10 is similar to a specific environment or specific control signal mapped with driving information, the power module 130 may be operated according to the corresponding driving information.

Similarly, when an environment of a time for which the lawn mower robot 10 operates or a control signal for operating the lawn mower robot 10 is similar to a specific environment or specific control signal mapped with rotation information, the power module 140 may be operated according to the corresponding rotation information.

The detection information storage module 530 stores each information detected by the travel sensor unit 200. Each information detected by the travel sensor unit 200 may be transmitted to the detection information storage module 530 through the travel information reception module 440. The detection information storage module 530 is electrically connected to the travel information reception module 440.

The detection information storage module 530 may store detection information according to a specific control signal and specific operation information. The detection information storage module 530 is electrically connected to the control signal storage module 510 and the operation information storage module 520.

The operation information stored in the detection information storage module 530 may be mapped with environment information, the control signal, and operation information all related to the operation of the lawn mower robot 10, and then stored.

That is, the detection information storage module 530 may classify and store information on an external environment, which is detected while the lawn mower robot 10 performs a task, according to a specific environment, a control signal, and operation information.

As described above, the information detected by the travel sensor unit 200 may include image information, distance information, location information, and rotation information. Accordingly, the detection information storage module 530 includes an image information storage unit 531, a distance information storage unit 532, a location information storage unit 533, and a rotation information storage unit 534.

The image information storage unit 531 stores transferred image information. The distance information storage unit 532 stores transferred distance information, and the location information storage unit 533 stores transferred location information.

In particular, the location information storage unit 533 may store information related to a terrain at a specific location in an area where the lawn mower robot 10 is performing a task.

In addition, the rotation information storage unit 534 stores transferred rotation information.

The information storage units 531, 532, 533, and 534 may be electrically connected to one another. In addition, the information stored in each of the information storage units 531, 532, 533, and 534 may be mapped with one another according to an operation time, an environment, and the like.

The travel record information storage module 540 stores reference direction information and deviation information calculated by the deviation information calculation module 460. The travel record information storage module 540 is electrically connected to the deviation information calculation module 460.

Also, the travel record information storage module 540 may store the first to fourth height information H1, H2, H3, and H4 detected by the height sensor unit 300.

The travel record information storage module 540 may receive the first to fourth height information H1, H2, H3, and H4 from the height information reception module 450. The travel record information storage module 540 is electrically connected to the height information reception module 450.

Each calculated information stored in the travel record information storage module 540 may be mapped with a control signal, operation information, and detection information, respectively. The travel record information storage module 540 is electrically connected to the control signal storage module 510, the operation information storage module 520, and the detection information storage module 530.

Therefore, the information calculated according to the specific control signal, operation information and detection information can be databased.

As a result, when an unpredictable situation occurs while the lawn mower robot 10 is operating, immediate response to the situation can be made by utilizing each information stored in the travel record information storage module 540 without repetitive calculation. Accordingly, the operation efficiency of the lawn mower robot 10 can be improved.

The information detection process of the travel sensor unit 200, the information detection process of the height sensor unit 300, the information processing and calculation process of the control unit 400, and the storing process of the database unit 500 may be performed in real time. In addition, these processes may be performed continuously.

A detailed description of an implementation in which the travel record information is stored in the database unit 500, in particular, in the travel record information storage module 540 will be described later.

The communication unit 600 is a part through which the lawn mower robot 10 transmits information to outside or receives information from the outside.

The communication unit 600 may receive information detected by the travel sensor unit 200 and the height sensor unit 300. The communication unit 600 is electrically connected to the travel sensor unit 200 and the height sensor unit 300.

The communication unit 600 may receive each information calculated by the control unit 400. The communication unit 600 is electrically connected to the control unit 400.

The communication unit 600 may receive each piece of information stored in the database unit 500. Also, the communication unit 600 is electrically connected to the database unit 500.

The communication unit 600 may transmit each received information to an external device E.D or a server S. The communication unit 600 is electrically connected to the external device E.D or the server S.

The communication unit 600 may be configured in any form capable of being electrically connected to other devices in a wired or wireless manner. In one implementation, the communication unit 600 may be configured as a Bluetooth module or a Wi-Fi module.

The communication unit 600 includes an information input module 610 and an information output module 620.

The information input module 610 receives information transmitted from the external device E.D or the server S. The information input module 610 is electrically connected to the external device E.D or the server S.

The information transmitted to the information input module 610 may be transmitted to the control unit 400 or the database unit 500. Also, the information input module 610 may receive information from the control unit 400 or the database unit 500. The information input module 610 is electrically connected to the control unit 400 or the database unit 500.

The information output module 620 transmits each information to the external device E.D or the server S. The information output module 620 is electrically connected to the external device E.D or the server S.

Each piece of information output by the information output module 620 may be transmitted to the travel sensor unit 200, the height sensor unit 300, the control unit 400, or the database unit 500. The information output module 620 is electrically connected to the travel sensor unit 200, the height sensor unit 300, the control unit 400, or the database unit 500.

### 6. Description of Method for Controlling Lawn Mower Robot 10 According to Implementation

In a method for controlling the lawn mower robot 10 according to an implementation, it may be determined whether the lawn mower robot 10 is traveling along a preset travel path. In the method for controlling the lawn mower robot 10 according to the implementation, the lawn mower robot 10 may be controlled to move back to the preset travel path when the lawn mower robot 10 is traveling by deviating from the preset travel path.

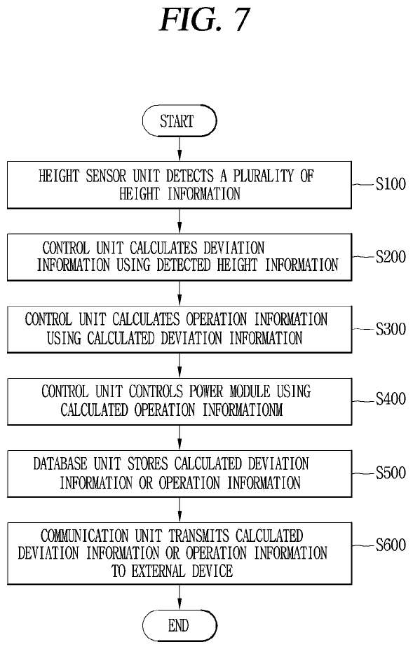

Hereinafter, a method for controlling a lawn mower robot according to an implementation will be described in detail with reference to FIGS. 7 to 13.

The method for controlling the lawn mower robot 10 according to the illustrated implementation includes detecting, by the height sensor unit 300, a plurality of height information H1, H2, H3, and H4 (S100), calculating, by the control unit 400, deviation information using the detected height information H1, H2, H3, and H4 (S200), calculating, by the control unit 400, operation information using the calculated deviation information (S300), controlling, by the control unit 400, the power module 130 according to the calculated operation information (S400), storing, by the database unit 500, the calculated deviation information or operation information (S500), and transmitting, by the communication unit 600, the calculated deviation information or operation information to the external device E.D or the server S (S600).

(1) Description of Step S100 of Detecting a Plurality of Height Information by Height Sensor Unit 300

This is a step in which the height sensor unit 300 detects height information H1, H2, H3, H4 in each area A1, A2, A3, A4 on a path (or route) on which the lawn mower robot 10 is traveling. As described above, the height sensor unit 300 is located at the front side of the blade 140.

Therefore, it will be understood that the height information H1, H2, H3, H4 of each area A1, A2, A3, A4 detected by the height sensor unit 300 is an area through which the blade 140 has not passed.

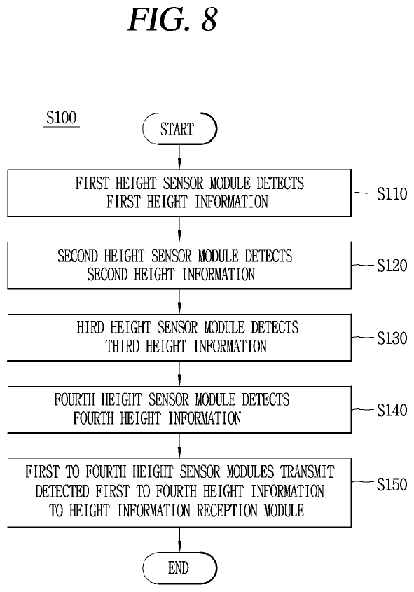

Hereinafter, this step will be described in detail with reference to FIG. 8.

The first height sensor module 310 detects the first height information H1 in the first area A1 (S110). The second height sensor module 320 detects the second height information H2 in the second area A2 (S120).

The third height sensor module 330 detects the third height information H3 in the third area A3 (S130). The fourth height sensor module 340 detects the fourth height information H4 in the fourth area A4 (S140).

As described above, each of the height sensor modules 310, 320, 330, and 340 may detect the height information H1, H2, H3, and H4 in real time and continuously.

Each of the height information H1, H2, H3, H4 detected by the first to fourth height sensor modules 310, 320, 330, and 340 is transmitted to the height information reception module 450 (S150).

The height sensor modules 310, 320, 330, and 340 are electrically connected to the height information reception modules 451, 452, 453, and 454, respectively.

(2) Description of Step S200 of Calculating, by Control Unit 400, Deviation Information Using Detected Height Information

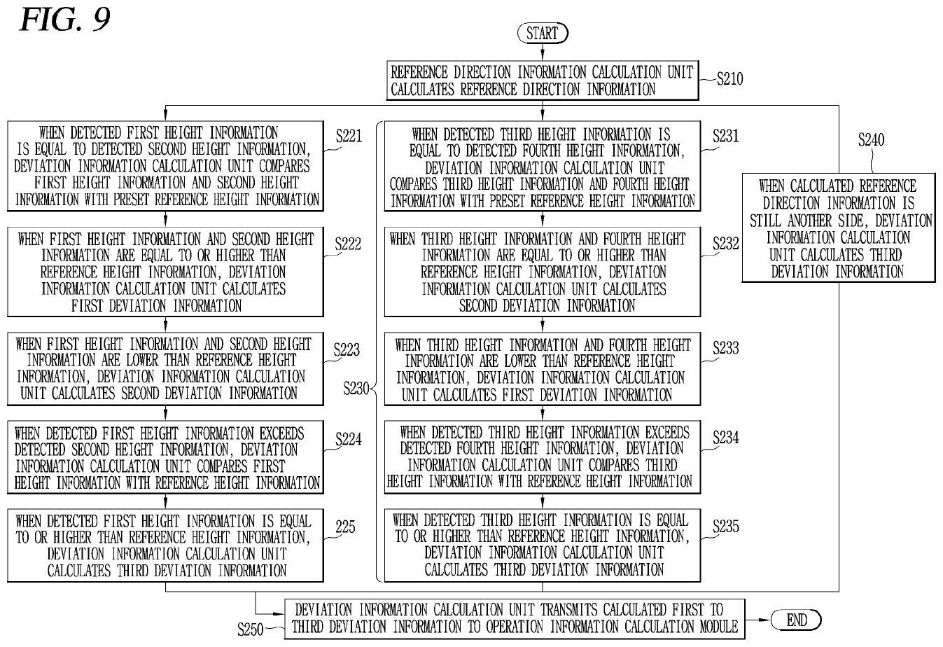

This is a step (S200) in which the deviation information calculation module 460 of the control unit 400 calculates deviation information by using the transmitted height information H1, H2, H3, H4. Hereinafter, this step will be described in detail with reference to FIG. 9.

Each of the height information H1, H2, H3, and H4 transmitted to each of the information reception modules 451, 452, 453, and 454 is transmitted to the deviation information calculation module 460. The information reception modules 451, 452, 453, and 454 are electrically connected to the deviation information calculation module 460.

First, the reference direction information calculation unit 461 calculates reference direction information (S210). As described above, the reference direction information may be calculated according to a direction between a path on which the lawn mower robot 10 is traveling and a path through which the lawn mower robot 10 has already passed. In one implementation, the reference direction information may be calculated as either one side (i.e., right side) or another side (i.e., left side).

However, as will be described later, a case in which there is no previously passed path at one side (i.e., right side) or another side (i.e., left side) of a path on which the lawn mower robot 10 is traveling may be taken into account. That is, the path on which the lawn mower robot 10 is traveling is a first path.

In the case, the reference direction information calculation unit 461 may calculate the reference direction information as still another side (front side).

The reference direction information calculated by the reference direction information calculation unit 461 is transmitted to the deviation information calculation unit 462.

The deviation information calculation unit 462 calculates deviation information by using the transmitted first to third height information H1, H2, H3, and H4 and the reference direction information.

As described above, the reference direction information may be calculated as any one of one side (i.e., right side), another side (i.e., left side), and still another side (i.e., front side).

Therefore, in the following description, different cases will be given depending on which direction is indicated by reference direction information.

Also, as described above, the first to fourth height information H1, H2, H3, and H4 may be detected in plurality, respectively. Accordingly, the deviation information calculation unit 462 may perform in advance a process of setting information having a minimum value, among the transmitted plurality of first to fourth height information H1, H2, H3, and H4, to the first to fourth height information H1, H2, H3, and H4.

First, a step (S220) of calculating deviation information using the first height information H1, the second height information H2, and the preset reference height information R.H detected by the deviation information calculation unit 462 when the calculated reference direction information is one side (i.e., right side) will be described.

The deviation information calculation unit 462 compares the transmitted first height information H1 and the second height information H2.

When the first height information H1 and the second height information H2 are the same, the deviation information calculation unit 462 compares the first height information H1 and the second height information H2 with the preset reference height information R.H (S221).

When the first height information H1 and the second height information H2 are equal to or higher than the reference height information R.H, the deviation information calculation unit 462 calculates first deviation information indicating that the lawn mower robot 10 has deviated to the one side (i.e., right side) from the preset travel path (S222).

That is, in the case, it may be determined that both the first area A1 and the second area A2 are located on the previously passed path. That is, the lawn mower robot 10 is running with being biased toward the previously passed path.

When the first height information H1 and the second height information H2 are lower than the reference height information R.H, the deviation information calculation unit 462 calculates second deviation information indicating that the lawn mower robot 10 has deviated to the another side (i.e., left side) from the preset travel path (S223).

That is, in the case, it may be determined that both the first area A1 and the second area A2 are located on the travel path through which the lawn mower robot 10 is to pass. That is, the lawn mower robot 10 is running with being biased toward the path along which it is to travel.

When the first height information H1 exceeds the second height information H2, the deviation information calculation unit 462 compares the first height information H1 with the reference height information R.H (S224).

When the first height information H1 is equal to or higher than the reference height information R.H, the deviation information calculation unit 462 calculates third deviation information indicating that the lawn mower robot 10 is traveling along the preset travel path (S225).

That is, in the case, it may be determined that the first area A1 is located on the travel path to be passed and the second area A2 is located on the previously passed path. That is, the lawn mower robot 10 is running along the preset path.

Next, a step (S230) of calculating deviation information using the third height information H3, the fourth height information H4, and the preset reference height information R.H detected by the deviation information calculation unit 462 when the calculated reference direction information is another side (i.e., left side) will be described.

When the third height information H3 and the fourth height information H4 are the same, the deviation information calculation unit 462 compares the third height information H3 and the fourth height information H4 with the preset reference height information R.H (S231).

When the third height information H3 and the fourth height information H4 are equal to or higher than the reference height information R.H, the deviation information calculation unit 462 calculates second deviation information indicating that the lawn mower robot 10 has deviated to the another side (i.e., left side) from the preset travel path (S232).

That is, in the case, it may be determined that both the third area A3 and the fourth area A4 are located on the previously passed path. That is, the lawn mower robot 10 is running with being biased toward the previously passed path.

When the third height information H3 and the fourth height information H4 are lower than the reference height information R.H, the deviation information calculation unit 462 calculates first deviation information indicating that the lawn mower robot 10 has deviated to the one side (i.e., right side) from the preset travel path (S233).

That is, in the case, it may be determined that both the third area A3 and the fourth area A4 are located on the travel path to be passed. That is, the lawn mower robot 10 is running with being biased toward the path along which it is traveling.

When the third height information H3 exceeds the fourth height information H4, the deviation information calculation unit 462 compares the third height information H3 with the reference height information R.H (S224).

When the third height information H3 is equal to or higher than the reference height information R.H, the deviation information calculation unit 462 calculates third deviation information indicating that the lawn mower robot 10 is traveling along the preset travel path (S235).

That is, in the case, it may be determined that the third area A3 is located on the travel path to be passed and the fourth area A4 is located on the previously passed path. That is, the lawn mower robot 10 is running along the preset path.

Next, a step (S240) of calculating deviation information using reference direction information calculated by the deviation information calculation unit 462 when the calculated reference direction information is still another side (i.e., front side) will be described.

As described above, when the calculated reference direction information is calculated as the still another side (i.e., the front side), the path on which the lawn mower robot 10 is traveling may be a first path. That is, it may be a case in which there is no previously passed path for calculating the reference direction information.

In this case, the deviation information calculation unit 462 calculates third deviation information indicating that the lawn mower robot 10 is traveling along the preset travel path (S240).

The deviation information calculation unit 462 transmits the first to third deviation information calculated through the processes to the operation information calculation module 420 (S250). The deviation information calculation unit 462 is electrically connected to the operation information calculation module 420.

(3) Description of Step S300 of Calculating, by Control Unit 400, Operation Information Using Calculated Deviation Information

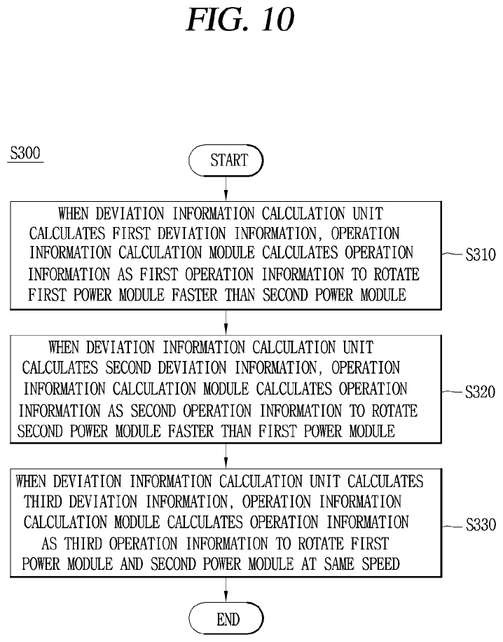

The operation information calculation module 420 of the control unit 400 calculates operation information for operating the power module 130 by using the calculated deviation information (S300). Hereinafter, this step will be described in detail with reference to FIG. 10.

The deviation information calculated by the deviation information calculation unit 462 is transmitted to the operation information calculation module 420. At this time, it may be understood that the deviation information calculated by the deviation information calculation unit 462 is any one of the first deviation information, the second deviation information, and the third deviation information.

When the transmitted deviation information is the first deviation information, the operation information calculation module 420 calculates first operation information, which is information for rotating the first power module 131 faster than the second power module 132 (S310).

That is, when the first deviation information is calculated, it means that the lawn mower robot 10 is traveling with being biased to one side (i.e., right side). Accordingly, in order for the lawn mower robot 10 to re-enter the preset travel path, the lawn mower robot 10 must travel toward another side (i.e., left side).

Accordingly, the operation information calculation module 420 calculates the first operation information that is information for rotating the first power module 131 located on the one side (i.e., the right side) to be faster than the second power module 132 located on the another side (i.e., the left side).

When the transmitted deviation information is the second deviation information, the operation information calculation module 420 calculates second operation information, which is operation information for rotating the second power module 132 faster than the first power module 131 (S320).

That is, when the second deviation information is calculated, it means that the lawn mower robot 10 is traveling with being biased to the another side (i.e., left side). Accordingly, in order for the lawn mower robot 10 to re-enter the preset travel path, the lawn mower robot 10 must travel toward the one side (i.e., the right side).

Accordingly, the operation information calculation module 420 calculates the second operation information that is operation information for rotating the second power module 132 located on the another side (i.e., the left side) to be faster than the first power module 131 located on the one side (i.e., the right side).

When the transmitted deviation information is the third deviation information, the operation information calculation module 420 calculates third operation information, which is operation information for rotating the first power module 131 and the second power module 132 at the same speed (S330).

That is, when the third deviation information is calculated, it means that the lawn mower robot 10 is traveling along the preset travel path. Therefore, the lawn mower robot 10 does not need to travel toward the one side (i.e., the right side) or the another side (i.e., the left side).

Accordingly, the operation information calculation module 420 calculates the third operation information that is information for rotating the first power module 131 located on the one side (i.e., the right side) and the second power module 132 located on the another side (i.e., the left side) at the same speed, so as to maintain a currently traveling direction of the lawn mower robot 10.

The operation information calculated by the operation information calculation module 420 is transmitted to the operation control module 430. The deviation information calculation module 420 is electrically connected to the operation information calculation module 430.

(4) Description of Step (S400) of Controlling, by Control Unit 400, Power Module 400 According to Calculated Operation Information

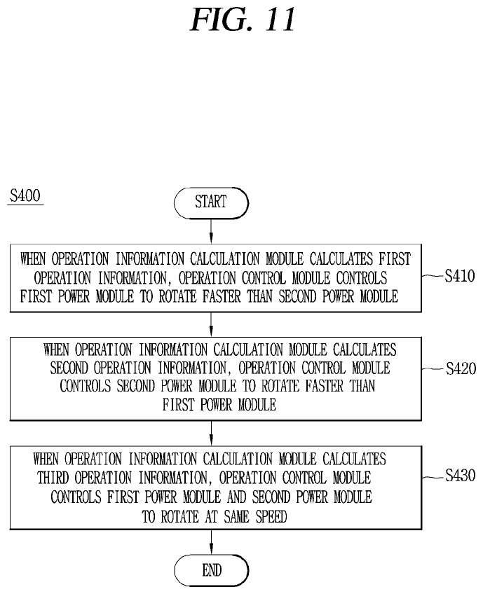

This is a step (S400) in which the operation control module 430 controls the power module 130 according to the operation information calculated by the operation information calculation module 420. Hereinafter, this step will be described in detail with reference to FIG. 11.

It will be understood that the operation information transmitted to the operation control module 430 is any one of the first operation information, the second operation information, and the third operation information.

When the operation information transmitted from the operation information calculation module 420 is the first operation information, the operation control module 430 controls the first power module 131 and the second power module 132 such that the first power module 131 rotates faster than the second power module 132 (S410).

When the operation information transmitted from the operation information calculation module 420 is the second operation information, the operation control module 430 controls the first power module 131 and the second power module 132 such that the second power module 131 rotates faster than the first power module 132 (S420).

When the operation information transmitted from the operation information calculation module 420 is the third operation information, the operation control module 430 controls the first power module 131 and the second power module 132 such that the first power module 131 and the second power module 132 rotate at the same speed (S430).

As described above, the operation control module 430 includes the first power module control unit 431 controlling the first power module 131 and a second power module control unit 432 controlling the second power module 132.

Accordingly, it will be understood that the first power module control unit 431 and the second power module control unit 432 independently control the first power module 131 and the second power module 132 to perform those processes.

Accordingly, the lawn mower robot 10 may can travel toward the one side (i.e., the right side), the another side (i.e., the left side), or the still another side (the front side), to return to the preset travel path.

(5) Description of Step (S500) of Storing, by Database Unit 500, Calculated Deviation Information or Operation Information

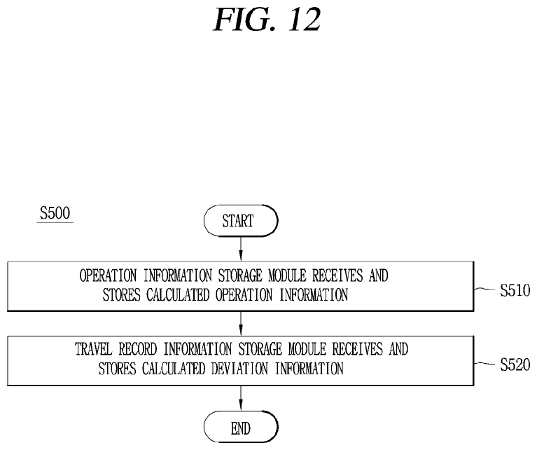

The deviation information calculated by the deviation information calculation module 460 or the operation information calculated by the operation information calculation module 420 is transmitted to the database unit 500 and cumulatively stored (S500). Hereinafter, this step will be described in detail with reference to FIG. 12.

The operation information calculation module 420 transmits the calculated operation information to the operation information storage module 520 of the database unit 500. The operation information calculation module 420 is electrically connected to the operation information calculation module 520.

The operation information storage module 520 stores the received operation information (S510). In this case, the operation information storage module 520 may store the operation information by mapping it with a time, position, and the like at which the operation information has been as calculated.

The deviation information calculation module 460 transmits the calculated deviation information to the travel record information storage module 540 of the database unit 500. In this case, the deviation information calculation module 460 may also transmit the received height information to the travel record information storage module 540. The deviation information calculation module 460 is electrically connected to the travel record information storage module 540.

The travel record information storage module 540 stores the received deviation information or height information (S520). In this case, the travel record information storage module 540 may store the deviation information or the height information by mapping it with a time, position and the like at which the deviation information has been calculated or the height information has been detected.

(6) Description of Step (S600) of Transmitting, by Communication Unit 600, Calculated Deviation Information or Operation Information to External Device E.D or Server S

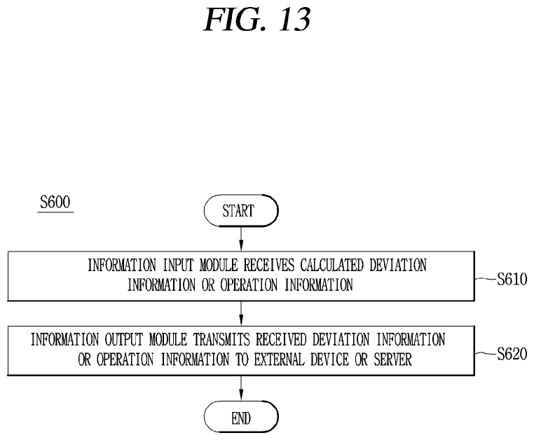

This is a step (S600) of transmitting the calculated deviation information or operation information to the external device E.D through the communication unit 600, so as to be output to the user or transmitted to the server S for storage. Hereinafter, this step will be described in detail with reference to FIG. 13.

The operation information calculation module 420 and the deviation information calculation module 460 transmit the calculated operation information to the information input module 610 of the communication unit 600 (S610). The information may include any one or more of the calculated deviation information, the calculated operation information, and the detected height information.

The information input module 610 is electrically connected to the operation information calculation module 420 and the deviation information calculation module 460.

Each information received by the information input module 610 is transmitted to the information output module 620.

The information output module 620 transmits the received information to the external device E.D or the server S (S620). The information output module 620 is electrically connected to the external device E.D or the server S.

Accordingly, each information collected and calculated while the lawn mower robot 10 travels may be output to the user in the form of visible information or audible information through the external device E.D. In addition, the information may be stored in the server S and utilized for artificial intelligence (A.I) learning related to the travel of the lawn mower robot 10.

### 7. Description of Implementation in which Lawn Mower Robot 10 Travels by Configuration of Lawn Mower Robot 10 and Control Method Thereof

The lawn mower robot 10 according to the implementation may detect height information that is a distance between grass existing on a travel path and the lower side of the lawn mower robot 10.

In addition, the lawn mower robot 10 may be controlled to travel along the preset travel path by calculating whether or not it has deviated from the preset travel path according to the detected height information.

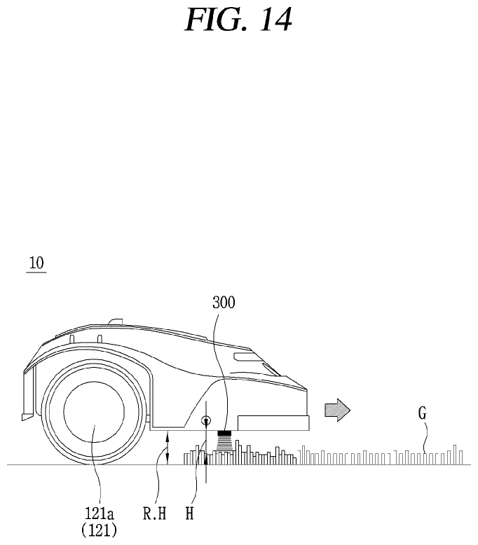

Hereinafter, an example of controlling the travel of the lawn mower robot 10 according to the implementation will be described in detail with reference to FIGS. 14 to 17.

FIG. 14 illustrates a state in which the lawn mower robot 10 according to the implementation travels. It will be understood that the implementation illustrates a state in which the lawn mower robot 10 is viewed from one side (i.e., right side). For convenience of understanding, illustration of the sub wheel 122 is omitted.

In the illustrated implementation, the lawn mower robot 10 travels from left to right. At this time, the height sensor unit 300 located at the front side of the main wheel 121 and the blade 140 detects the height information H1, H2, H3, H4 that is a distance between the grass G and the lower side of the lawn mower robot 10.

As described above, the distance between the ground where there is no grass G and the like and the lawn mower robot 10 is defined as the reference height information R.H, and the distance between the grass G and the lawn mower robot 10 is defined as the height information H1, H2, H3, H4.

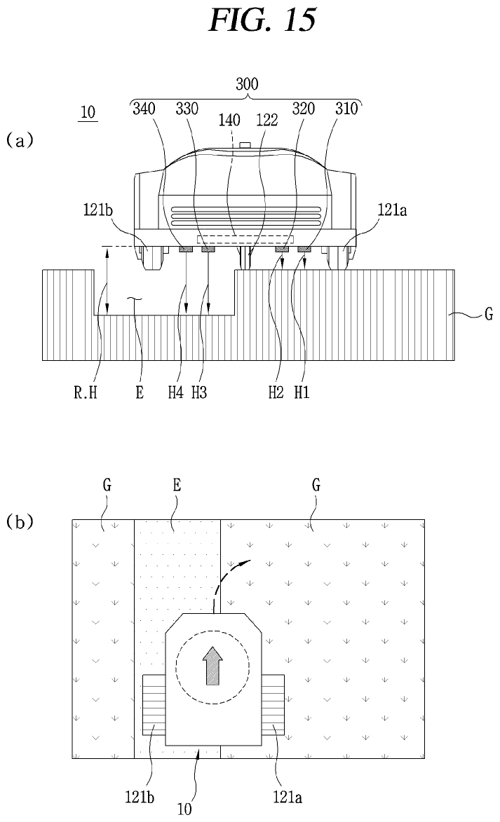

Referring to FIGS. 15 to 17, a state in which the lawn mower robot 10 according to the implementation travels is illustrated.

In the illustrated implementation, it will be understood that the reference direction information is the another side (i.e., the left side).

That is, when it is assumed that the traveling direction of the lawn mower robot 10 is the front side, an area E in which the lawn mowing operation has been performed is located at the another side (i.e., the left side) of the lawn mower robot 10.

Accordingly, in the illustrated implementation, the third height information H3 and the fourth height information H4 detected by the third height sensor module 330 and the fourth height sensor module 340 are used to calculate the deviation information.

In the implementation illustrated in (a) of FIG. 15, the third height information H3 and the fourth height information H4 have the same value. In addition, the third height information H3 and the fourth height information H4 are the same as the reference height information R.H.

Accordingly, as described above, the deviation information calculation unit 460 calculates the second deviation information indicating that the lawn mower robot 10 is biased to the another side (i.e., the left side).

Referring to (b) of FIG. 15, a process in which operation information is calculated according to the second deviation information calculated through the above process and the lawn mower robot 10 is moved to the one side (i.e., the right side) is illustrated (see a dotted arrow).

The calculated second deviation information is transferred to the operation information calculation module 420. The operation information calculation module 420 calculates second operation information for rotating the second main wheel 121b faster than the first main wheel 121a according to the calculated second deviation information.

The operation control module 430 receives the calculated second operation information and controls the second power module 132 to rotate faster than the first power module 131. Accordingly, the lawn mower robot 10 can be moved to the one side (i.e., the right side) so as to return to the preset travel path.

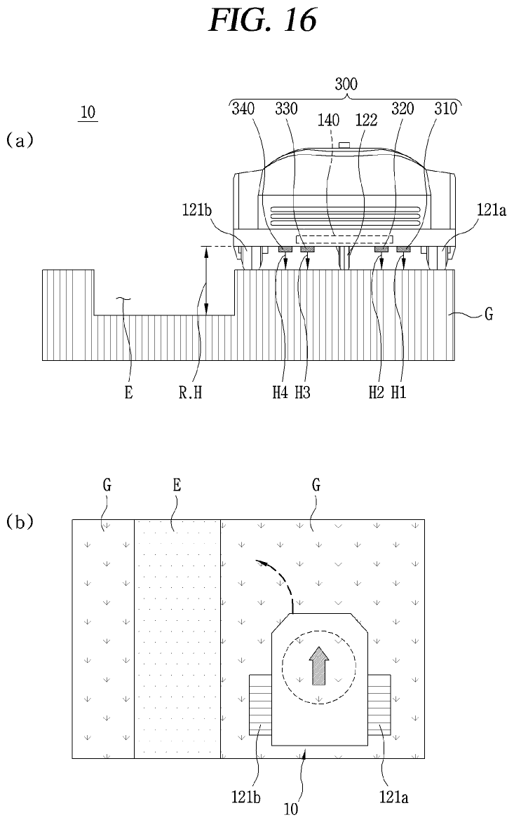

In the implementation illustrated in (a) of FIG. 16, the third height information H3 and the fourth height information H4 have the same value. In addition, the third height information H3 and the fourth height information H4 are lower than the reference height information R.H.

Accordingly, as described above, the deviation information calculation unit 460 calculates the first deviation information indicating that the lawn mower robot 10 is biased to the one side (i.e., the right side).

Referring to (b) of FIG. 16, a process in which operation information is calculated according to the first deviation information calculated through the above process and the lawn mower robot 10 is moved to the another side (i.e., the left side) is illustrated (see a dotted arrow).

The calculated first deviation information is transferred to the operation information calculation module 420. The operation information calculation module 420 calculates first operation information for rotating the first main wheel 121a faster than the second main wheel 121b according to the calculated first deviation information.

The operation control module 430 receives the calculated first operation information and controls the first power module 131 to rotate faster than the second power module 132. Accordingly, the lawn mower robot 10 can be moved to the another side (i.e., the left side) so as to return to the preset travel path.

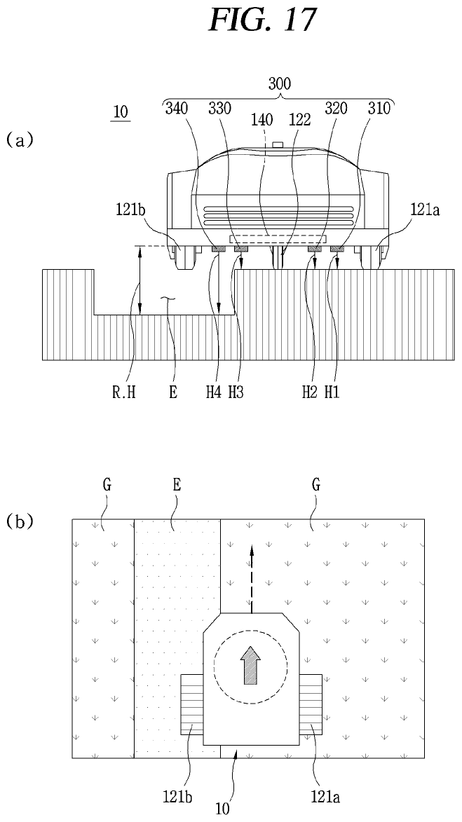

In the implementation illustrated in (a) of FIG. 17, the third height information H3 exceeds the fourth height information H4. In addition, the third height information H3 is the same as the reference height information R.H.

Accordingly, as described above, the deviation information calculation unit 460 calculates the third deviation information indicating that the lawn mower robot 10 is biased to the still another side (i.e., the front side).

Referring to (b) of FIG. 17, a process in which operation information is calculated according to the third deviation information calculated through the above process and the lawn mower robot 10 continuously travels toward the still another side (i.e., the front side) is illustrated (see a dotted arrow).

The calculated third deviation information is transferred to the operation information calculation module 420. The operation information calculation module 420 calculates third operation information for rotating the first main wheel 121a and the second main wheel 121b at the same speed according to the calculated third deviation information.

The operation control module 430 receives the calculated third operation information and controls the first power module 131 and the second power module 132 to rotate at the same speed. Accordingly, the lawn mower robot 10 can be moved toward the still another side (i.e., the front side) and continue to travel along the path along which it is traveling.

Therefore, according to the lawn mower robot 10 and its control method, whether the lawn mower robot 10 has deviated from a preset travel path can be detected, and if it has deviated, the lawn mower robot 10 can be controlled to return to the travel path.

### 8. Description of Implementation in which Travel Record Information of Lawn Mower Robot 10 is Stored

In the lawn mower robot 10 and its control method according to the implementation, travel record information that is information related to results of the travel of the lawn mower robot 10 operated according to operation information may be stored.

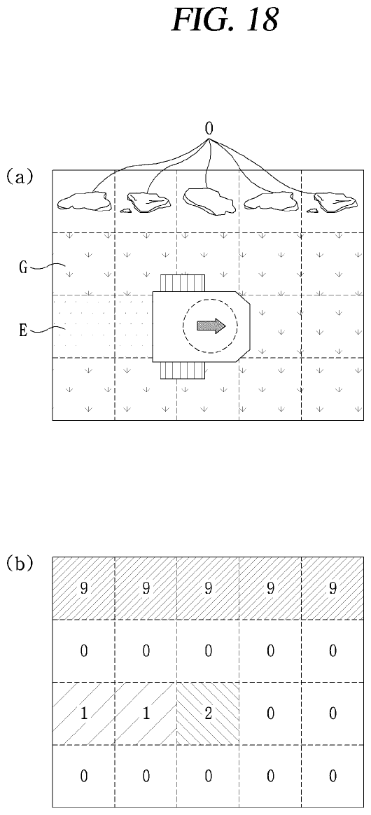

Hereinafter, an example of storing travel record information of the lawn mower robot 10 according to the implementation will be described in detail with reference to FIGS. 18 to 24.

FIG. 18 illustrates a state in which the lawn mower robot 10 according to the implementation starts to travel. In the illustrated implementation, the lawn mower robot 10 travels from left to right.

In (a) of FIG. 18, an area in which the lawn mower robot 10 is located may be divided into an area E in which the lawn mowing operation has been performed and an area G in which the lawn mowing operation has not been performed.

In the illustrated implementation, the lawn mower robot 10 is in a state in which there is not a path through which it has passed. In other words, the lawn mower robot 10 is in a state in which the reference direction information calculation unit 461 cannot calculate reference direction information

Referring to (b) of FIG. 18, information related to an area in which the lawn mower robot 10 is located is expressed in numbers.

In the illustrated implementation, “1” denotes an area through which the lawn mower robot 10 has already passed while mowing the lawns. Also, “2” denotes an area in which the lawn mower robot 10 is currently located to mow the lawns. In addition, “0” denotes an area in which the lawn mower robot 10 does not enter and thus it is not known what state the area is in.

Further, areas marked with “9” are areas where obstacles are present and thereby the lawn mower robot 10 cannot enter. In the illustrated implementation, obstacles such as a rock and the like are located in the areas marked with 9.

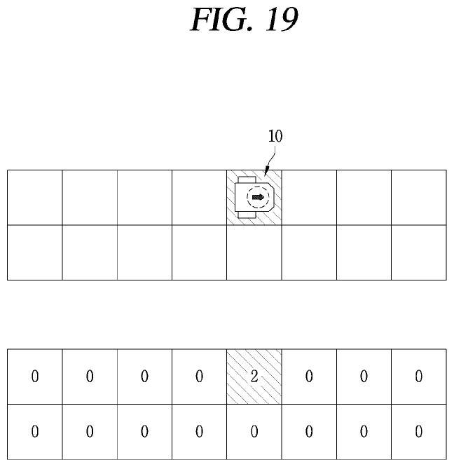

Referring to FIG. 19, an implementation of travel record information stored as the lawn mower robot 10 travels is illustrated.

As described above, “2” denotes the area in which the lawn mower robot 10 is currently located while mowing the lawns. Also, as can be seen from a direction indicated by an arrow, the lawn mower robot 10 is moved from left to right in the illustrated implementation.

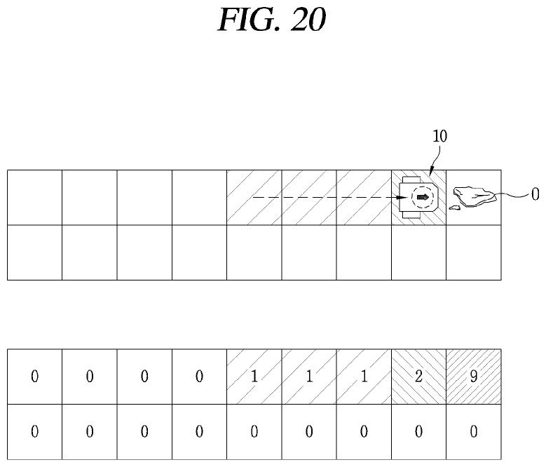

FIG. 20 illustrates a state in which the lawn mower robot 10 has moved from left to right. An obstacle O is located on the travel path of the lawn mower robot 10, so that the lawn mower robot 10 can no longer move toward the right.

Referring to a table below, the path through which the lawn mower robot 10 has already passed is marked with 1. In addition, an area where the lawn mower robot 10 is located with being in contact with the obstacle O is marked with 2, and the area in which the obstacle O is located is marked with 9.

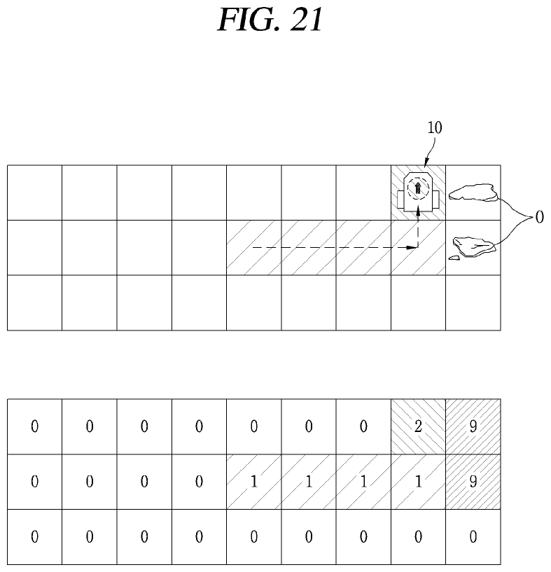

Referring to FIG. 21, the lawn mower robot 10 that can no longer travel to the right due to the presence of the obstacle O is rotated to another side (i.e., the left side).

Accordingly, an area in which “2” is marked is located above the area in which “2” was marked. It may also be understood that the area in which “2” was marked in FIG. 20 has changed to be marked with “1”.

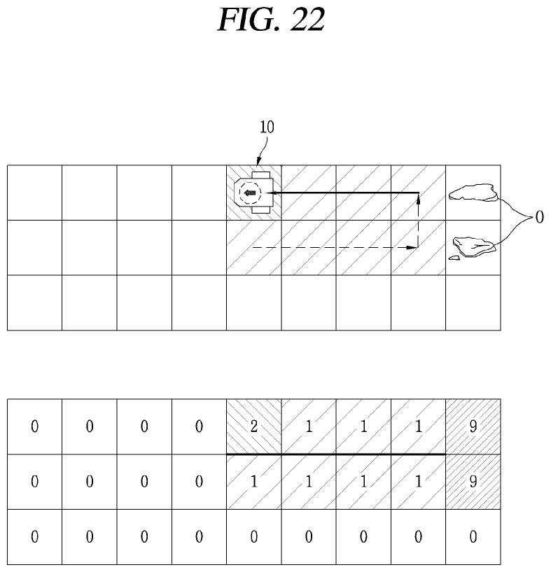

Referring to FIG. 22, the lawn mower robot 10 is rotated once more to the another side (i.e., the left side), and travels in a direction from right to left.

In the state, it will be understood that the reference direction information is calculated as the another side of the lawn mower robot 10, that is, the left side.

Also, it will be understood that, in the above state, the reference direction information is calculated as the another side (i.e., the left side).

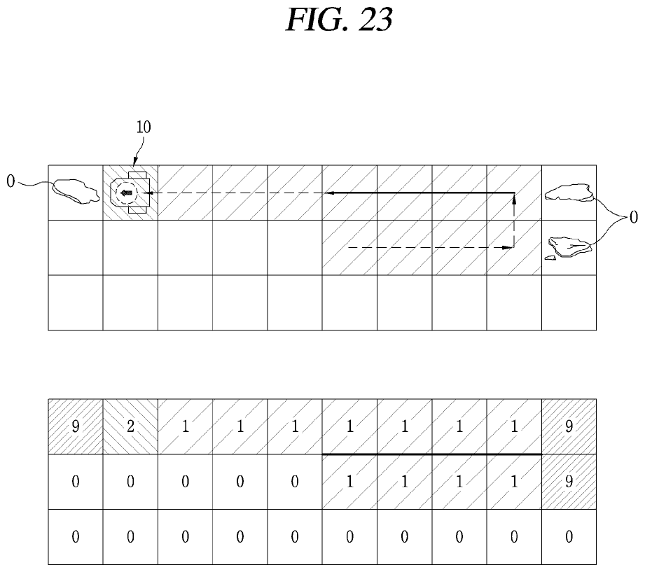

Referring to FIG. 23, as the lawn mower robot 10 continuously travels, it comes in contact with another obstacle o.

Also in the case, an area through which the lawn mower robot 10 has already passed is marked with 1, and an area in which the lawn mower robot 10 stays is marked with 2.

In this state, the lawn mower robot 10 travels over a previously passed path. Therefore, in the illustrated implementation, the reference direction information is calculated as the still another side (i.e., the front side).

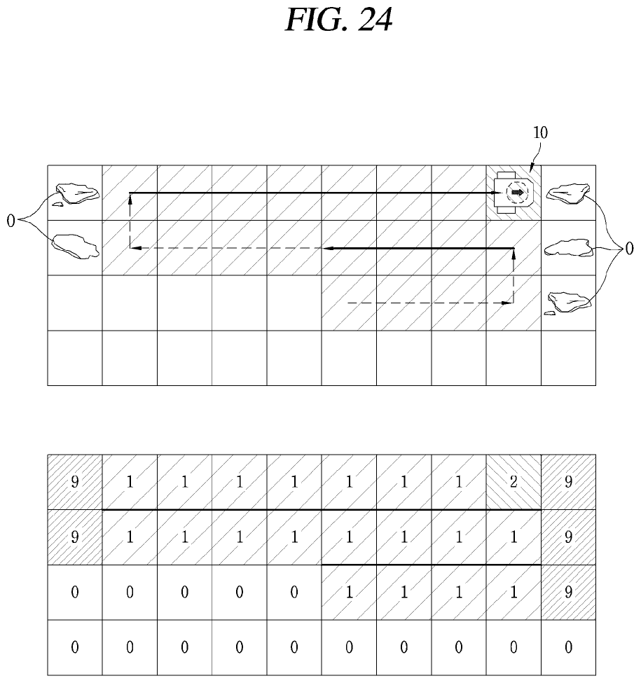

Referring to FIG. 24, the lawn mower robot 10 in contact with the obstacle o on the left is then rotated to the right twice, and travels in a direction from left to right.

Referring to a lower part of FIG. 24, it is shown that each area of the table that is stored changes to 1 as the lawn mower robot 10 travels.

Also, in the above state, the lawn mower robot 10 is moved so that the path that it has already passed is located on the right side. Accordingly, in the illustrated implementation, the reference direction information is calculated as the right side.

As described above, the database unit 500 according to the implementation can store information on a path along which the lawn mower robot 10 travels and information related to a result of the travel. At this time, an area where the lawn mower robot 10 has not entered, an area where the lawn mower robot 10 enters and performs the lawn mowing operation, an area where the lawn mower robot 10 has already passed, and an area where the obstacle o exists are marked with specific numbers and stored in the travel record information storage module 540.

Therefore, in the lawn mower robot 10 according to the implementation and its control method, whether or not the lawn mower robot 10 has deviated from the preset travel path can be detected. Also, when the lawn mower robot 10 has deviated from the preset travel path, it can be controlled to be returned to the travel path.

Furthermore, the path traveled by the lawn mower robot 10 and the grass G and obstacles o located on the path can be stored in the travel record information storage module 540. Accordingly, when the lawn mower robot 10 travels next time, it can more efficiently perform the lawn mowing operation by using such stored information.

The foregoing description has been given of the preferred implementations, but it will be apparent to those skilled in the art that various modifications and variations can be made in the present disclosure without departing from the scope of the disclosure as defined in the appended claims.
10: Lawn mower robot
100: Body unit
110: Housing
120: Driving module
121: Main wheel
121a: First main wheel
121b: Second main wheel
122: Sub wheel
130: Power module
131: First power module
132: Second power module
140: Blade
141: Plate
142: Blade motor
143: Sub blade
143a: First sub blade
143b: Second sub blade
200: Travel sensor unit
210: Image sensor module
220: Distance sensor module
221: First distance sensor module
222: Second distance sensor module
223: Third distance sensor module
230: Location sensor module
240: Rotation sensor module
241: First rotation sensor module
242: Second rotation sensor module
243: Third rotation sensor module
300: Height sensor
310: First height sensor module
320: Second height sensor module
330: Third height sensor module
340: Fourth height sensor module
400: Control unit
410: Control signal input module
420: Operation information calculation module
421: Driving information calculation unit
421a: First driving information calculation unit
421b: Second driving information calculation unit
422: Rotation information calculation unit
430: Operation control module
431: First power module control unit
432: Second power module control unit
433: Blade motor control unit
440: Travel information reception module
441: Image information reception unit
442: Distance information reception unit
443: Location information reception unit
444: Rotation information reception unit
450: Height information reception module
451: First height information reception module
452: Second height information reception module
453: Third height information reception module
454: Fourth height information reception module
460: Deviation information calculation module
461: Reference direction information calculation unit
462: Deviation information calculation unit
500: Database unit
510: Control signal storage module
520: Operation information storage module
521: Driving information storage module
522: Rotation information storage module
530: Detection information storage module
531: Image information storage unit
532: Distance information storage unit
533: Location information storage unit
534: Rotation information storage unit
540: Travel record information storage module
600: Communication unit
610: Information input module
620: Information output module
G: Grass
E.D: External device
S: Server
A1: First area
A2: Second area
A3: Third area
A4: Fourth area
H1: First height information
H2: Second height information
H3: Third height information
H4: Fourth height information
R.H: Reference height information

1. A lawn mower robot comprising:
a body unit;
main wheels provided in plurality and arranged to face each other at a distance therebetween, the main wheels rotatably coupled to the body unit;
a power module provided in plurality to be connected to the main wheels, respectively, and configured to be rotated according to operation information so as to rotate the main wheels;
a blade located between the plurality of main wheels and rotatably coupled to a lower side of the body unit;
a plurality of height sensor modules located at the front of the blade on the lower side of the body unit, and configured to detect height information of the lower side of the body unit with respect to a ground; and
a control unit communicatively connected to the power modules and the height sensor modules, respectively, and configured to calculate the operation information using the detected height information, and rotate the power module according to the calculated operation information,
wherein some of the plurality of height sensor modules are located to be biased to any one of the plurality of main wheels, and
wherein remaining height sensor modules of the plurality of height sensor modules are located to be biased to another one of the plurality of main wheels.

2. The lawn mower robot of claim 1, wherein the plurality of height sensor modules comprise:
a first height sensor module and a second height sensor module located to be biased toward the one main wheel and spaced apart from each other; and
a third height sensor module and a fourth height sensor module located to be biased toward the another main wheel and spaced apart from each other; and.

3. The lawn mower robot of claim 2, wherein the first height sensor module is located between the one main wheel and the blade, and
wherein the second height sensor module is located to at least partially overlap the blade in front and rear directions.

4. The lawn mower robot of claim 2, wherein the third height sensor module is located between the another main wheel and the blade, and
wherein the fourth height sensor module is located to at least partially overlap the blade in front and rear directions.

5. The lawn mower robot of claim 2, wherein the control unit calculates deviation information using first height information detected by the first height sensor module, second height information detected by the second height sensor module, and preset reference height information, and
calculates the operation information using the calculated deviation information, and
wherein the deviation information is information related to whether the lawn mower robot travels to be biased to one side or another side or travels straight.

6. The lawn mower robot of claim 2, wherein the control unit calculates deviation information using third height information detected by the third height sensor module, fourth height information detected by the fourth height sensor module, and preset reference height information, and
calculates the operation information using the calculated deviation information, and
wherein the deviation information is information related to whether the lawn mower robot travels to be biased to one side or another side or travels straight.

7. The lawn mower robot of claim 1, wherein each of the plurality of height sensor modules detects a plurality of height information, and
wherein the control unit calculates the operation information by using any one height information having a minimum value among the plurality of the height information detected by each of the plurality of height sensor modules.

8. The lawn mower robot of claim 1, wherein the plurality of height sensor modules comprise:
a first height sensor module located between the one main wheel and the blade, and configured to detect first height information related to an area between the one main wheel and the blade; and
a second height sensor module located to be opposite to the one main wheel with the first height sensor module interposed therebetween, and located to at least partially overlap the blade in front and rear directions to detect second height information related to an overlapping area with the blade in the front and rear directions.

9. The lawn mower robot of claim 8, wherein the plurality of height sensor modules comprise:
a third height sensor module located between the another main wheel and the blade, and configured to detect third height information related to an area between the another main wheel and the blade; and
a fourth height sensor module located to be opposite to the another main wheel with the third height sensor module interposed therebetween, and located to at least partially overlap the blade in the front and rear directions to detect fourth height information related to an overlapping area with the blade in the front and rear directions.

10. The lawn mower robot of claim 9, wherein the blade is rotatably coupled to the lower side of the body unit, and includes a plate formed in a disc shape having a predetermined width, and
wherein the plate comprises:
a first sub blade located to be adjacent to the one main wheel and extending toward the one main wheel; and
a second sub blade located to be adjacent to the another main wheel and extending toward the another main wheel.

11. The lawn mower robot of claim 10, wherein the first height sensor module is located between an end portion of the first sub blade facing the one main wheel and the one main wheel, and
wherein the second height sensor module is disposed such that the end portion of the first sub blade is located between the one main wheel and the second height sensor module.

12. The lawn mower robot of claim 10, wherein the third height sensor module is located between an end portion of the second sub blade facing the another main wheel and the another main wheel, and
wherein the fourth height sensor module is disposed such that the end portion of the second sub blade is located between the another main wheel and the fourth height sensor module.

13. A method for controlling a lawn mower robot, the method comprising:
(a) detecting, by a height sensor unit, a plurality of height information;
(b) calculating, by a control unit, deviation information using the detected height information;
(c) calculating, by the control unit, operation information using the calculated deviation information; and
(d) controlling, by the control unit, power modules according to the calculated operation information.

14. The method of claim 13, wherein the step (a) comprises:
(a1) detecting, by the first height sensor module, first height information;
(a2) detecting, by the second height sensor module, second height information;
(a3) detecting, by the third height sensor module, third height information;
(a4) detecting, by the fourth height sensor module, fourth height information.

15. The method of claim 14, wherein the step (b) comprises:
(b1) calculating, by a reference direction information calculation unit, reference direction information; and
(b2) calculating, by a deviation information calculation unit, deviation information by comparing the detected first height information and second height information and preset reference direction information when the calculated reference direction information is one side;
(b3) calculating, by the deviation information calculation unit, deviation information by comparing the detected third height information and fourth height information and the preset reference direction information when the calculated reference direction information is another side; and
(b4) calculating, by the deviation information calculation unit, third deviation information when the calculated reference direction information is still another side.

16. The method of claim 15, wherein the step (b2) comprises:
(b21) comparing, by the deviation information calculation unit, the first height information and the second height information with the preset reference height information when the detected first height information is equal to the detected second height information;
(b22) calculating, by the deviation information calculation unit, first deviation information when the first height information and the second height information are equal to or higher than the reference height information; and
(b23) calculating, by the deviation information calculation unit, second deviation information when the first height information and the second height information are lower than the reference height information.

17. The method of claim 16, wherein the step (b2) comprises:
(b24) comparing, by the deviation information calculation unit, the first height information with the preset reference height information when the detected first height information exceeds the detected second height information; and
(b25) calculating, by the deviation information calculation unit, third deviation information when the detected first height information is equal to or higher than the reference height information.

18. The method of claim 15, wherein the step (b3) comprises:
(b31) comparing, by the deviation information calculation unit, the third height information and the fourth height information with the preset reference height information when the detected third height information is equal to the detected fourth height information;
(b32) calculating, by the deviation information calculation unit, second deviation information when the third height information and the fourth height information are equal to or higher than the reference height information; and
(b33) calculating, by the deviation information calculation unit, first deviation information when the third height information and the fourth height information are lower than the reference height information.

19. The method of claim 18, wherein the step (b3) comprises:
(b34) comparing, by the deviation information calculation unit, the third height information with the preset reference height information when the detected third height information exceeds the detected fourth height information; and
(b35) calculating, by the deviation information calculation unit, third deviation information when the detected third height information is equal to or higher than the reference height information.

20. The method of claim 13, wherein the step (c) comprises:
(c1) calculating, by an operation information calculation module, the operation information as first operation information for rotating a first power module faster than a second power module when a deviation information calculation unit calculates first deviation information;
(c2) calculating, by the operation information calculation module, the operation information as second operation information for rotating the second power module faster than the first power module when the deviation information calculation unit calculates second deviation information;
(c3) calculating, by the operation information calculation module, the operation information as third operation information for rotating the first power module and the second power module at the same speed when the deviation information calculation unit calculates third deviation information.

21. The method of claim 13, wherein the step (d) comprises:
(d1) controlling, by an operation control module, a first power module to rotate faster than a second power module when an operation information calculation module calculates first operation information;
(d2) controlling, by the operation control module, the second power module to rotate faster than the first power module when the operation information calculation module calculates second operation information;
(d3) controlling, by the operation control module, the first power module and the second power module to rotate at the same speed when the operation information calculation module calculates third operation information.
